(19) United States
(12) Patent Application Publication
(10) Pub. No.: US 2019/0199128 A1
(43) Pub. Date: Jun. 27, 2019

(54) MOBILE ELECTRIC POWER GENERA TING AND CONDITIONING SYSTEM

(71) Applicant: New Energy Corporation Inc., Calgary (CA)

(72) Inventors: Derek Neufeld, Winnipeg (CA); Clayton Bear, Calgary (CA)

(21) Appl. No.: 15/779,036

(22) PCT Filed: Nov. 24, 2016
(86) PCT No.: PCT/CA2016/051380

§ 371 Date: May 24, 2018

Related U.S. Application Data
(60) Provisional application No. 62/259,335, filed on Nov. 24, 2015.

(51) Int. Cl. H02J 13/00; H02K 7/18; H02S 10/40; H02J 7/00; H02J 9/06; H02M 7/217; F03B 7/00; F03B 15/00

(52) U.S. Cl. CPC H02J 13/00; H02K 7/1823; H02S 10/40; H02J 7/0013; H02M 1/44; H02M 7/217; F03B 7/00; F03B 15/00; H02J 9/061

(57) ABSTRACT

A mobile power conditioning system that does not require a battery comprises an energy-capturing assembly and a power conditioner. The energy-capturing assembly converts captured energy into an electric-power input. The power conditioner comprises an input terminal, a primary-output terminal, a controller and a secondary output terminal. The power conditioner receives the electrical power input and delivers a conditioned electrical power output. The primary-output terminal is configured to receive and transfer part or all of the conditioner output to a primary load. The controller regulates the transfer of an un-transferred portion of the conditioner output to the secondary output terminal so that an aggregated draw from the first output terminal and the second output terminal is less than or equal to the conditioner output. The secondary output terminal is configured to transfer the un-transferred portion of the electrical power input to a secondary load.

### TECHNICAL FIELD

The present disclosure relates to the field of power-generation systems. In particular, the present disclosure relates to the field of mobile power generation and conditioning systems.

### BACKGROUND

Providing power to remote locations that are too far from a utility transmission or distribution grid often requires a power-generating system. Typical power-generating systems that are used at such remote locations include a mechanism for harnessing energy and converting it into useable electric power, a controller and one or more batteries. Solar panels and wind or water turbines are examples of some common harnessing mechanisms. The batteries store the electric power and can provide it to one or more devices that require electric power to operate. Once the batteries are fully charged, the conversion to useable electric power is typically discontinued to prevent damage to the batteries.

Some very remote areas do not have access to a road and the power-generating system must be transported in by people or animals. The batteries used in the power-generating systems are typically heavy and difficult to transport to these very remote areas. The product lifecycle of the batteries that are typically used in power-generating systems may also pose an environmental risk. Furthermore, once a battery is no longer operational it must be transported away from the very remote area for disposal, which also can be difficult.

### SUMMARY

The embodiments of the present disclosure relate to a power-conditioning system. The system comprises an energy-capturing assembly and a power conditioner. The energy-capturing assembly converts captured energy, such as mechanical captured energy, chemical captured energy or other forms of captured energy, into an electric-power input for the power conditioner. The power conditioner comprises an input terminal, a primary-output terminal, a controller and a secondary-output terminal. The power conditioner receives the electrical power input and delivers a conditioned electrical-power output. The primary-output terminal is configured to receive and transfer part or all of the conditioner output to a primary load. A controller, for example a SCADA controller, regulates the transfer of an un-transferred portion of the conditioner output to the secondary-output terminal so that an aggregated draw from the first-output terminal and the second-output terminal is less than or equal to the conditioner output. The secondary-output terminal is configured to transfer the un-transferred portion of the electrical-power input to a secondary load.

The power-conditioning system of the present disclosure is mobile and portable by able-bodied people and animals. In other words, the power-conditioning system is light enough that it does not require a motorized vehicle for transport. The portability of the system allows it to be transported to and set up in remote areas where there is restricted or no access to a utility transmission or distribution grid. Very remote areas also generally do not have road access.

In one embodiment of the present disclosure, the energy-capturing assembly is a water turbine that can be placed in flowing water to provide the electric power output for 24 hours a day. The electric-power output may be a variable voltage that is conditioned by the power conditioner into a constant-voltage output within a voltage range that is typical of a battery power source. The power conditioner can provide a constant-voltage power source to meet the power requirements of the primary load, thus replacing the need for a battery, while directing any additional power available on either the input terminal or the primary-output terminal to the secondary output terminal, thus emulating the accumulator properties of a battery. Since the power conditioner can emulate the power source and accumulator properties of a battery, a battery need not be included in the total weight of equipment that will be transported as part of the power-conditioning system. Avoiding the use of a battery may also reduce or mitigate the known negative environmental-impact associated with using and/or, disposing of batteries.

In some embodiments of the present disclosure the power-conditioning system may emulate a battery insofar as the power-conditioning system is compatible with an energy-capturing assembly and one or more primary loads. In some embodiments of the present disclosure the one or more primary loads may be one or more inverters, pumps or combinations thereof. This compatibility is achieved through conditioning of the electrical power created via the energy-capturing assembly. For example the conditioning may occur via voltage selection or other methods. In some embodiments of the present disclosure the power-conditioning system may exceed the capabilities of a typical battery because the power-conditioning system may act as a power sink. When there is energy available that is in excess of the requirements of the primary load, the power sink properties may be accomplished through the use of one or more further loads, such as: water heaters to preheat water for drinking, bathing, cooking or other uses; one or more pumps to pump water into a water tower so that the potential and kinetic energy of the stored water can be extracted through a turbine at a later point in time; or an air compressor to compress air into a containment vessel. Each of these non-limiting examples of how the power-conditioning system may act as a power sink allow storage of energy for a later point in time. These alternative methods of storing energy have the advantage over batteries of being: a) environmentally friendly; b) of greater capacity, which may be considered virtually infinite for small-scaled systems; and c) of simple implementation and low cost. By implementing an energy storage system that can be approximated as infinite, this device accomplishes maximum power-point tracking until the cumulative input power reaches power rating and/or the power specifications of the power-conditioning system. That is, the power-conditioning system may ensure that all available power is being consumed by all connected loads. This cannot be practically accomplished through batteries because the cost of batteries may be prohibitively high. The power-conditioning system may also provide the ability to accomplish practical energy-storage without the introduction of potentially damaging chemicals, as may occur with batteries.

### BRIEF DESCRIPTION OF THE DRAWINGS

These and other features of the present disclosure will become more apparent in the following detailed description in which reference is made to the appended drawings.

FIG. 1 is a schematic diagram of an example of a power-conditioning system according to an embodiment of the present disclosure;

FIG. 2 is a schematic diagram of circuitry for another example of a power-conditioning system according to an embodiment of the present disclosure;

FIG. 3 is a schematic diagram of an example of a power conditioner for use with the system of FIG. 1;

FIG. 4 is a schematic diagram of an example of a power conditioner, as in FIG. 2, with separate input and output converters;

FIG. 5 is a schematic diagram of circuitry for an example of an input inverter for use with the system of FIG. 1;

FIG. 6 is a schematic diagram of circuitry for an example of an input-inverter controller for use with the system of FIG. 1;

FIG. 7 is a schematic diagram of circuitry for an example of an input inverter driver for use with the system of FIG. 1;

FIG. 8 is a schematic diagram circuitry for a three-phase instrumentation board for use with the system of FIG. 1;

FIG. 9 is a schematic diagram circuitry for an example of an output converter for use with the system of FIG. 1;

FIG. 10 is a schematic diagram circuitry for an example of an output rectifier for use with the system of FIG. 1;

FIG. 11 is a schematic diagram circuitry for an example of an output inverter for use with the system of FIG. 1;

FIG. 12 is a schematic diagram circuitry for an example of an instrument board for use with the system of FIG. 1;

FIG. 13 is a schematic diagram of another example of a power-conditioning system according to an embodiment of the present disclosure;

FIG. 14 is a schematic diagram circuitry for an example of a high-voltage auxiliary power supply for use with the system of FIG. 1;

FIG. 15 is a schematic diagram circuitry for an example of an alternating current (AC) auxiliary-power supply inverter for use with the system of FIG. 1;

FIG. 16 is a schematic diagram circuitry for an auxiliary power supply instrument board for use with the system of FIG. 1;

FIG. 17 is a schematic diagram circuitry for an example of a battery management converter for use with the system of FIG. 1;

FIG. 18 is a schematic diagram circuitry for an example of a switch component for use with the system of FIG. 1; and

FIG. 19 is a schematic diagram of another example of a power-conditioning system according to an embodiment of the present disclosure.

### DETAILED DESCRIPTION

Embodiments of the present disclosure relate to a power-conditioning system that comprises an energy-capturing assembly and a power conditioner that is capable of capturing energy from an energy source. The energy-capturing assembly converts the captured energy into an electric-power input. The electric-power input is transferred into a power conditioner. The power conditioner conditions the electric-power input into a form of electric energy that is usable by loads that otherwise would be powered by batteries. The useable form of electric power is transferred to at least a primary load and a secondary load. The primary load will have higher priority of access to the useable form of electric power so that the primary load's power requirements are met. The power conditioner may include a controller that regulates the transfer of the useable form of electric power to the secondary load. The controller ensures that an aggregated power draw from both the primary load and the secondary load can meet but not exceed the total amount of power available from the electric-power input.

Unless defined otherwise, all technical and scientific terms used herein have the same meaning as commonly understood by one of ordinary skill in the art to which this disclosure belongs.

As used herein, the term “about” refers to a variation from a given value within an approximate range of about +/−10%. It is to be understood that such a variation is always included in any given value provided herein, whether or not it is specifically referred to.

As used herein, the term “electric power” refers to the rate at which electric energy is transferred through the one or more circuits; however, depending upon the context of use the terms “electric power” and “power” may also be used herein to refer to the electric energy that is being transferred within the power-conditioning system and to one or more loads that are electrically connected to the power-conditioning system.

As used herein, the term “power conditioning” refers to a process for modulating and/or distributing electric energy to match a load's preferred characteristics of voltage level, current level, current type, frequency and quality.

As used herein, the term “power conditioner” refers to a device that performs at least part of the power conditioning process.

As used herein, the terms “transfer”, “transferred” and “transferring” refer to the movement of electric energy from one part of the power-conditioning system to another. This movement of electric energy may occur by conduction, non-radiative power transfer techniques or radiative power transfer techniques.

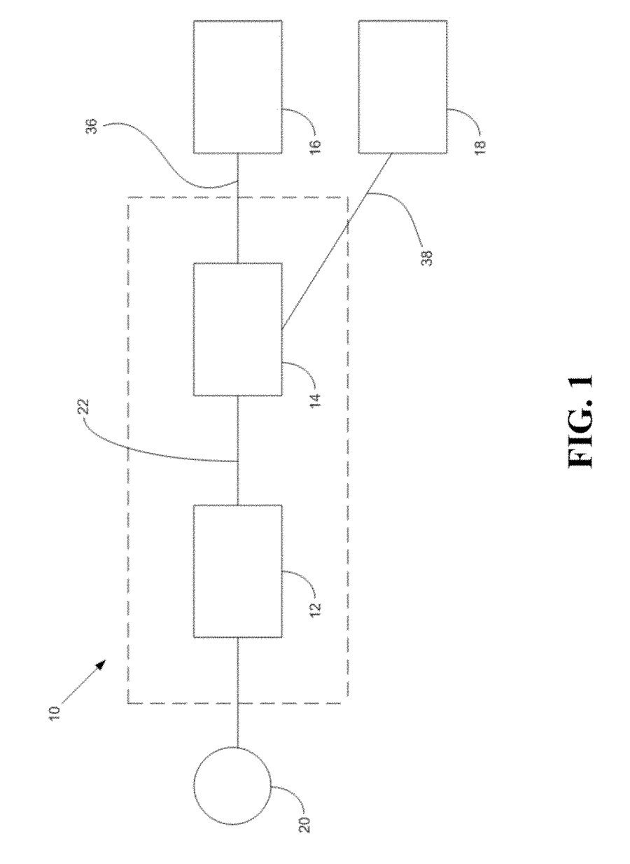

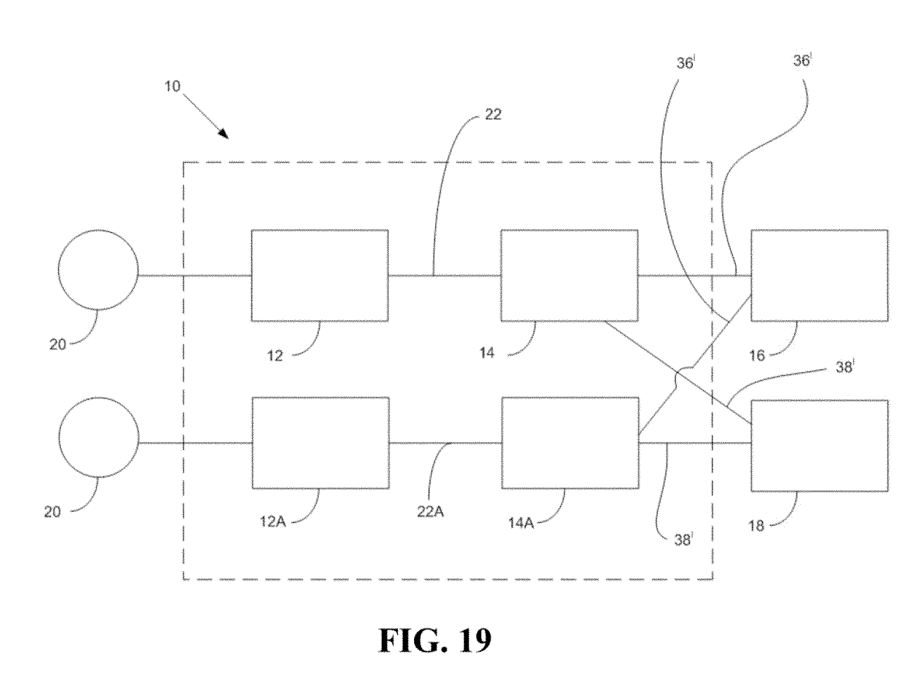

Embodiments of the present disclosure will now be described by reference to FIG. 1 through to FIG. 19, which show representative embodiments of a power-conditioning system 10 according to the present disclosure.

FIG. 1 depicts one embodiment of the present disclosure that relates to the power-conditioning system 10. The power-conditioning system 10 comprises an energy-capturing assembly 12 and a power conditioner 14 that is electrically connectible to a primary load 16 and a secondary load 18.

The energy-capturing assembly 12 captures energy from an energy source 20. The energy source 20 may provide non-electrical energy, such as chemical energy, solar energy, or potential energy and kinetic energy from a flowing fluid. In one embodiment of the present disclosure the energy-capturing assembly 12 is one or more solar panels for capturing solar energy and the energy source 20 is the sun. In another embodiment of the present disclosure the energy-capturing assembly 12 includes a turbine and an associated generator for capturing energy from a flowing fluid. If the energy source 20 is a flowing gas, such as wind, then the turbine is a wind turbine. If the energy source 20 is a flowing liquid, such as water, then the turbine is a water turbine. The turbine converts the kinetic potential energy of the flowing fluid into mechanical work. The associated generator may be an electric generator that converts the mechanical work of the rotating turbine into electrical energy. The energy-capturing assembly 12 may also be referred to herein as an electrical-generating assembly.

The energy-capturing assembly 12 converts the captured energy into a useable form of electric energy that is referred to herein as an electric-power input 22. The electric-power input 22 may be an alternating current (AC) or a direct current (DC) that is of a substantially constant voltage (V), a substantially variable voltage, a substantially constant current (A) or a variable current. In one embodiment of the present disclosure the electric-power input 22 may be within a power range of about 10 watts (W) to about a megawatt. In another embodiment of the present disclosure the energy-capturing assembly 12 may produce the electric-power input 22 within a power range of between about 5 kilowatts (KW) and about 100 KW. In another embodiment of the present disclosure, the energy-capturing assembly 12 may produce the electrical-power input 22 up to 5 kilowatts (kW).

In one embodiment of the present disclosure the electric-power input 22 is a nominal voltage of about 100 VAC to about 300 VAC root mean square (rms) open-circuit, line-to-line three phase output at a frequency of about 10 Hertz (Hz) to about 30 Hz. The open circuit voltage may be proportional to the frequency. In the embodiments of the energy-capturing assembly 12 that comprise a turbine and associated generator, the impedance from the associated generator may have low resistive and inductive properties. In some embodiments of the present disclosure, the impedance of the associated generator may have a resistive property measured between about 0.01 Ohms to about 0.1 Ohms and an inductive property measured between about 1 milli henry (mH) to about 10 mH. In other embodiments of the present disclosure, the impedance of the associated generator may be relatively higher, for example between about 1.5 Ohms and about 2.5 Ohms resistive with an inductive property measured between about 100 mH and about 200 mH. In one embodiment of the present disclosure, the associated generator has a resistive property of 2 Ohms and an inductive property of about 140 mH.

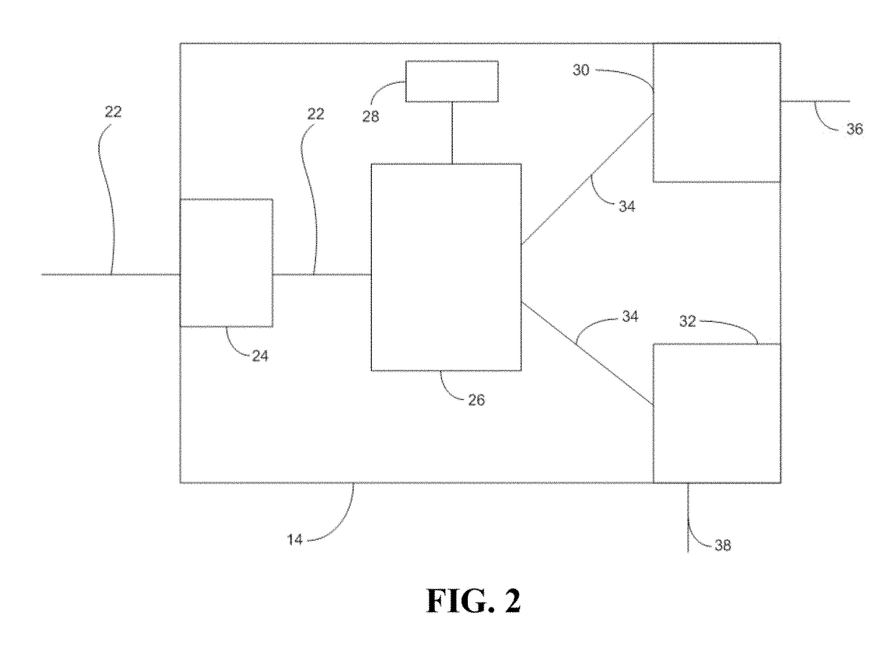

The electric-power input 22 is transferred to the power conditioner 14. As shown in FIG. 2, the power conditioner may comprise an input terminal 24, a power converter 26, a supervisory control and acquisition system (SCADA) controller 28 (as discussed further below), the primary-output terminal 30 and the secondary output terminal 32. In some embodiments of the present disclosure the SCADA controller 28 has a display and one or more user-accessible input ports and output ports.

The power conditioner 14 includes the input terminal 24 for receiving and transferring the electric-power input 22 to the power converter 26. The power converter 26 conditions the transferred electric-power input 22 into a conditioner electric power output 34, which may also be referred to herein as the conditioner output 34. The power converter 26 may comprise various components that are selected from a group consisting of a DC to DC converter, DC to DC transformer, a DC to DC voltage regulator, a DC to DC linear regulator, a DC to AC inverter, an AC to DC rectifier, an AC to AC converter, an AC to AC voltage regulator or an AC to AC transformer, depending on whether the electric-power input 22 is an AC input or a DC input. Depending upon the specific components of the power converter 26, the conditioner output 34 may be a substantially constant voltage, a substantially variable voltage, a substantially constant current or a substantially variable current. The conditioner output 34 provides conditioned electric energy that meets the operational requirements, characteristics or preferences of any loads that are electrically connected to the power-conditioning system 10, for example the primary load 16 and the secondary load 18. The primary load 16 and the secondary load 18 may have the same operational requirements or preferences, or not. For example, the primary load 16 may receive a DC primary output in the range of a typical battery source and the secondary load 18 may receive an AC secondary output. In this example, the secondary load 18 may be operated as a switched on/off load.

When the power-conditioning system 10 is operating the power conditioner 14 may present capacitive impedance at the input terminal 24 that is proportional to the inductive impedance of the associated generator. This may avoid an excessive voltage drop if the inductive impedance of the associated generator is high, which is important if nominal electrical energy is going to be conditioned and transferred to the electrically connected loads 16, 18. In embodiments of the present disclosure that do not include the associated generator, the power conditioner 14 may not present a capacitive impedance at the input terminal 24.

In some embodiments of the present disclosure, real power available in the electric-power input 22 may vary according to the cube law with two transfer speeds from about 625 watts (W) at about 150 VAC to about 5 kilowatts (KW) at about 300 VAC. In other embodiments of the present disclosure the real power available in the electric-power input 22 may be higher.

In one embodiment of the present disclosure a voltage offload may be available in the range of 0 to 400 V, line-to-line. The voltage offload may avoid damage or degradation of internal components of the conditioner system 14 if the electric-power input 22 of the capturing assembly 12 exceeds a safe or non-damaging limit. Optionally, the input current shall be monitored and actively regulated so that it does not exceed 10 A per line, as discussed further below.

In one embodiment of the present disclosure the power converter 26 is a DC to DC converter that converts the electric-power input 22 from a variable voltage DC to a constant voltage DC conditioner output 34. In this embodiment, the power converter 26 may further comprise a switch assembly for facilitating conversion of the variable voltage DC electric-power input 22 to the constant voltage DC conditioner output 34.

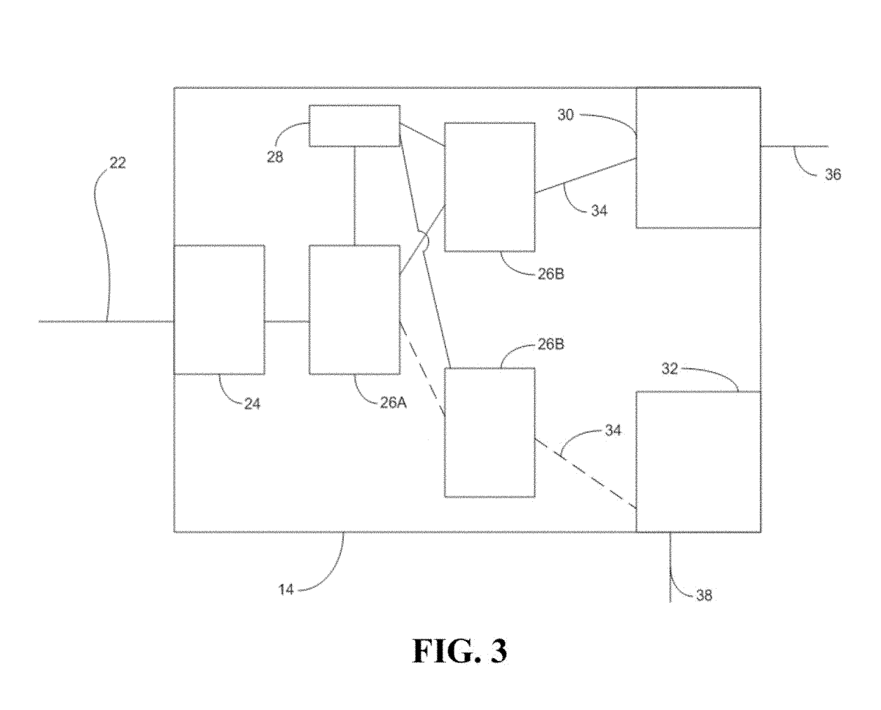

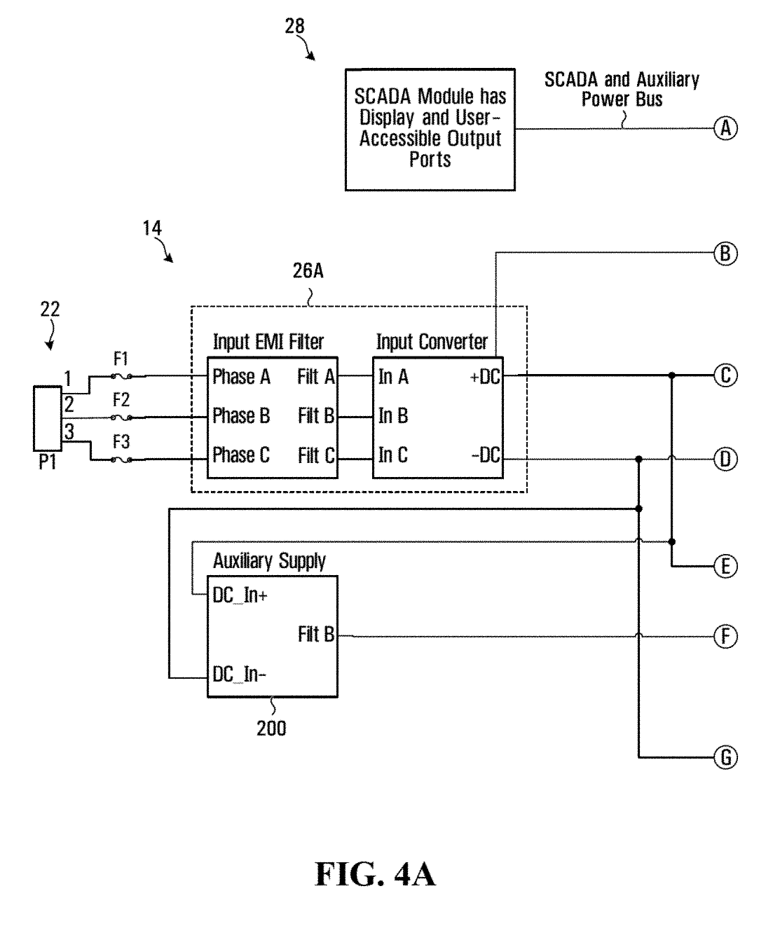

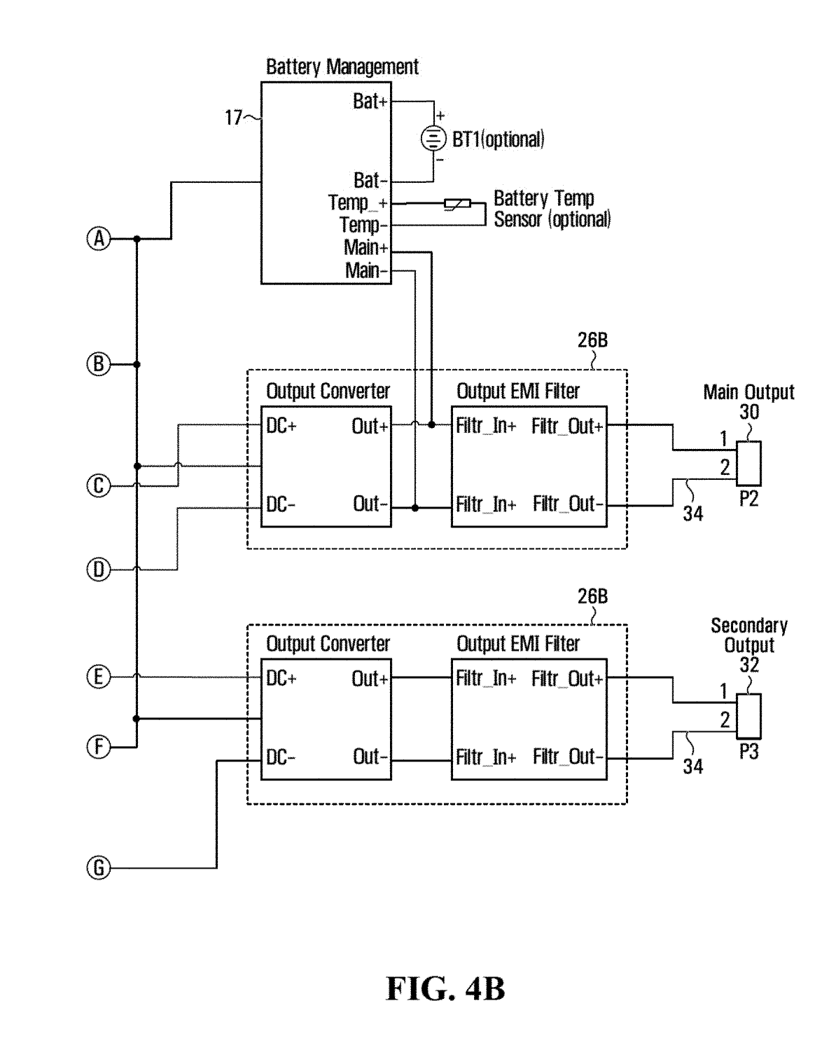

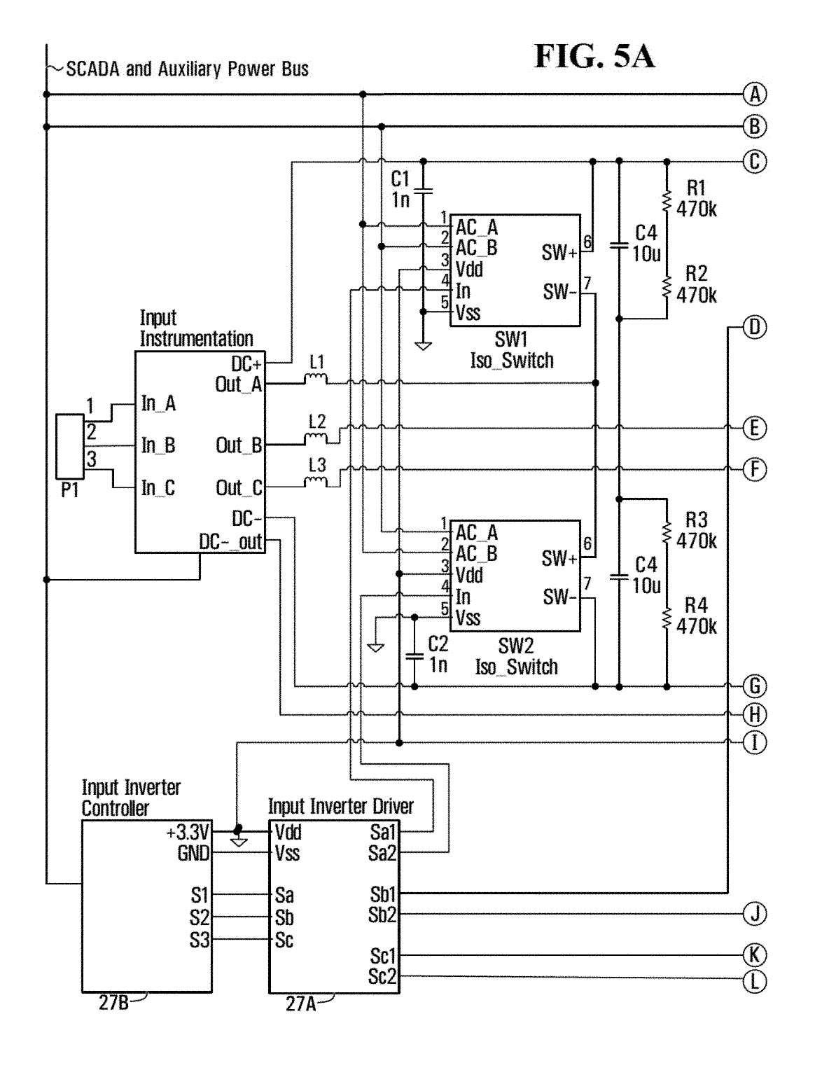

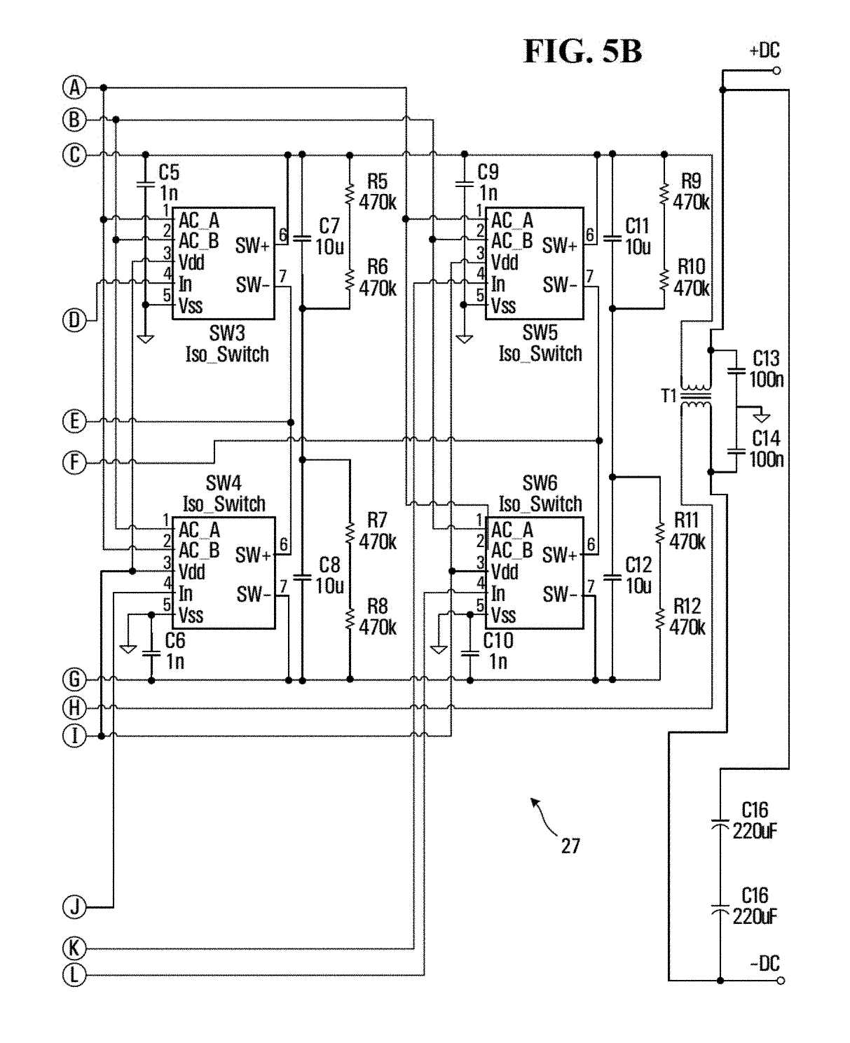

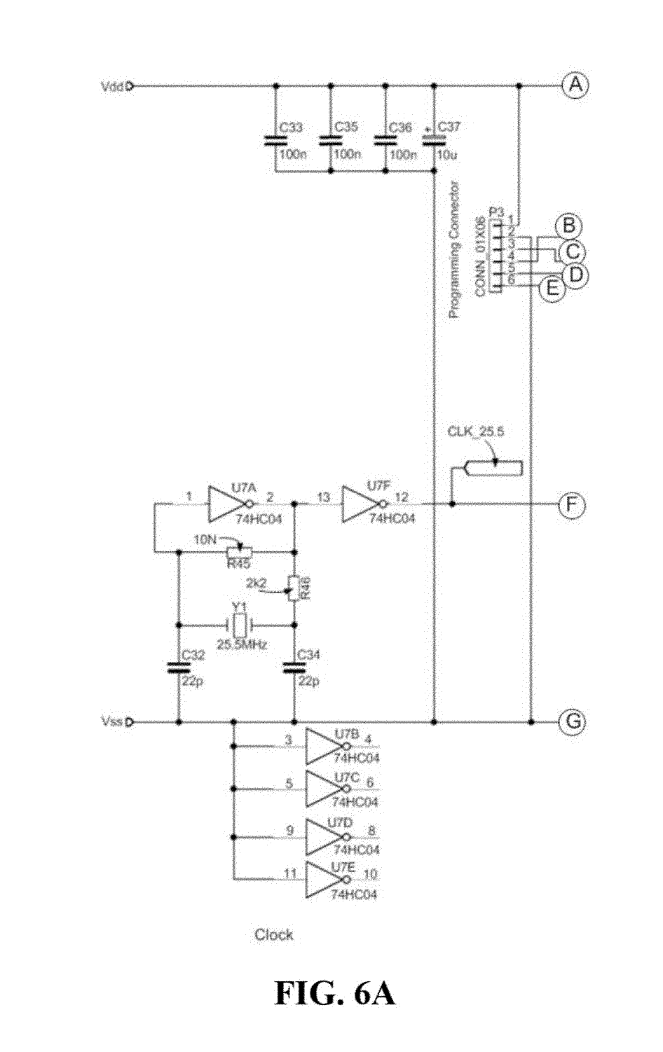

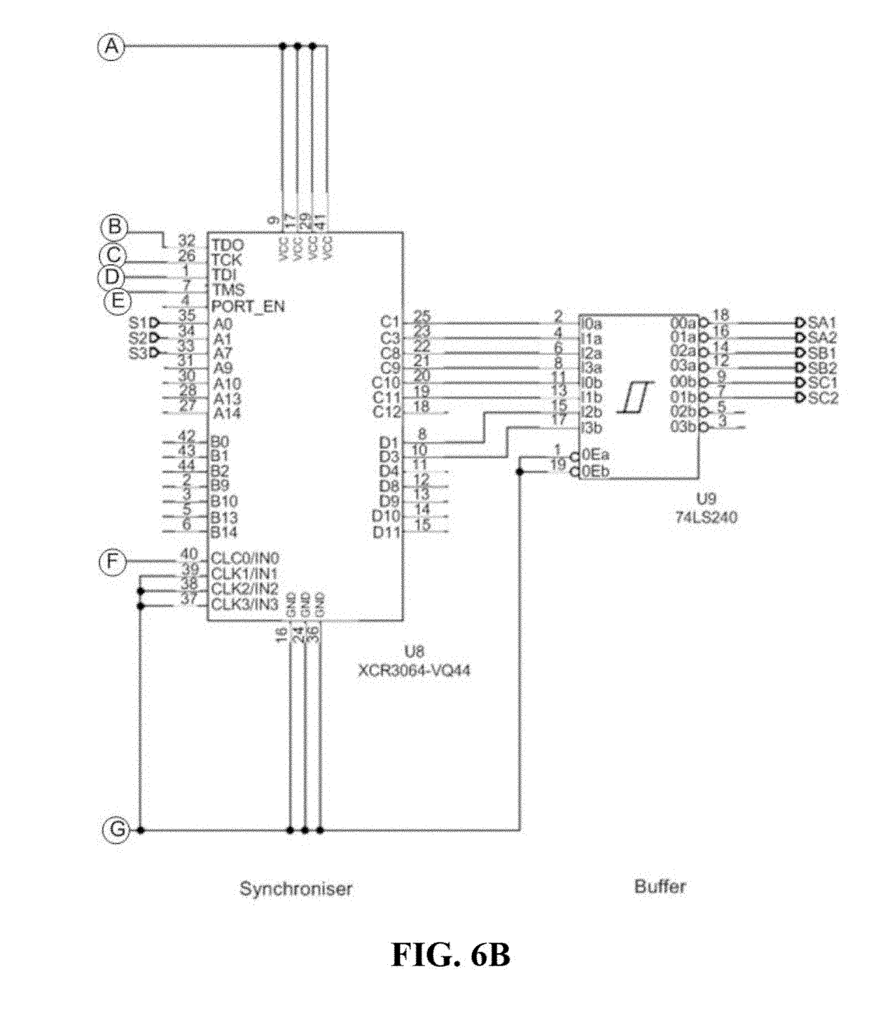

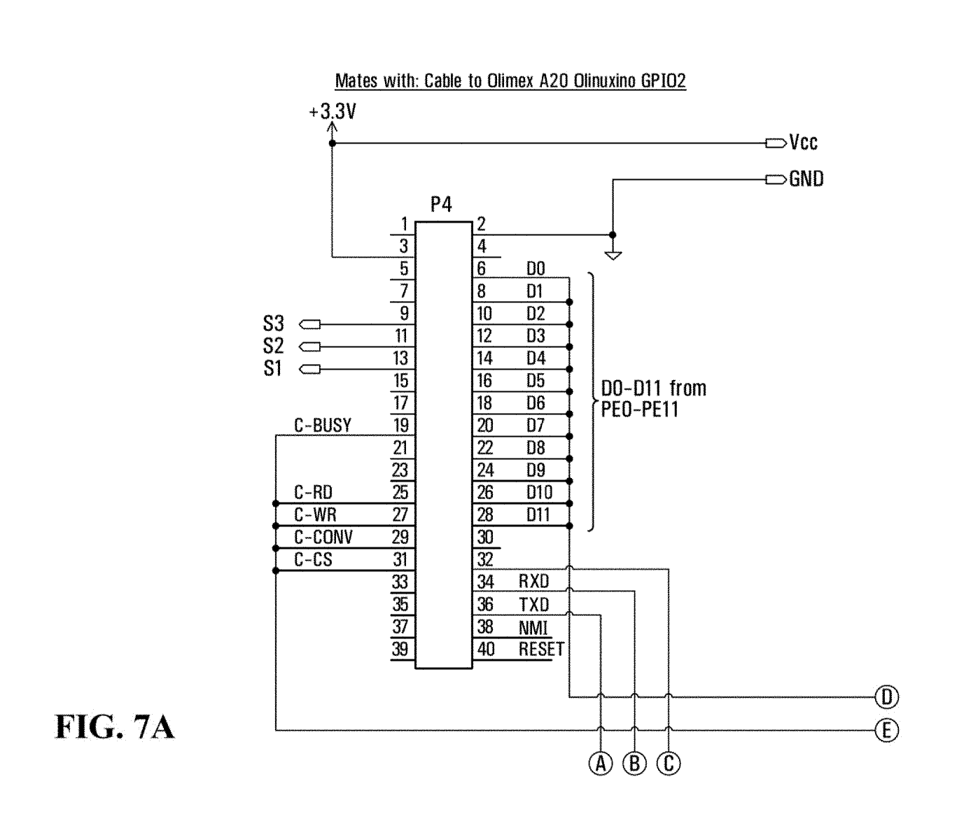

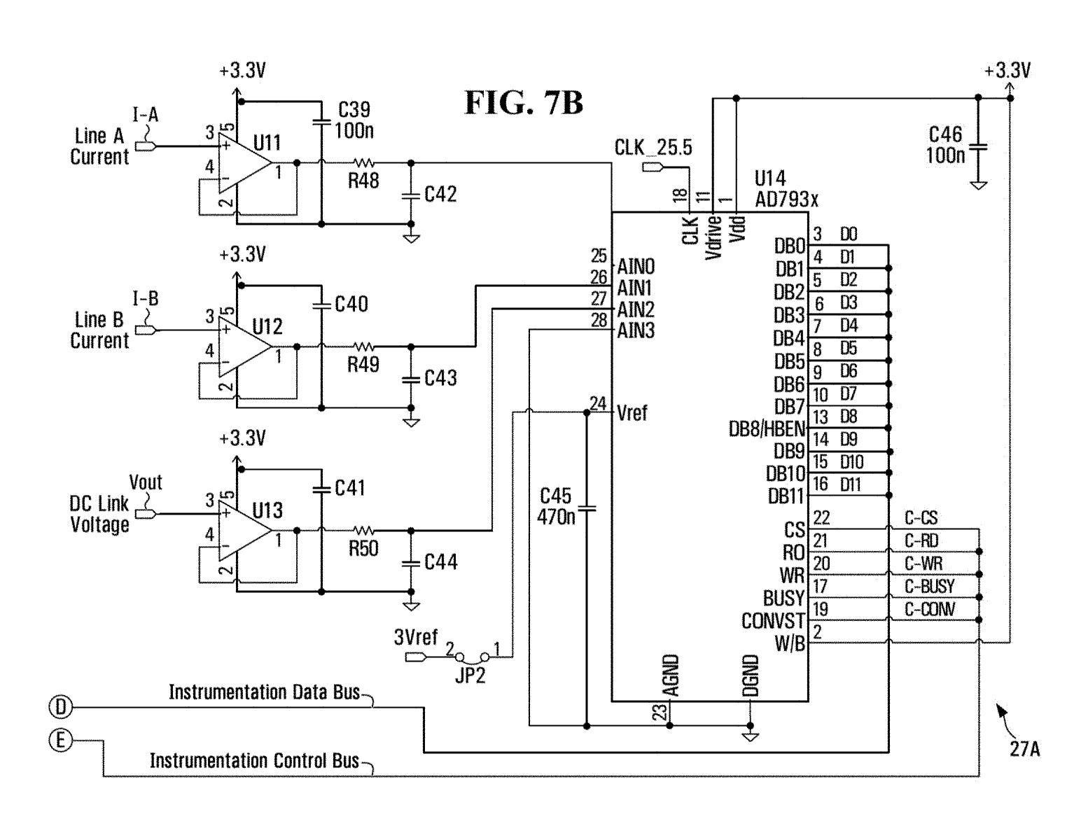

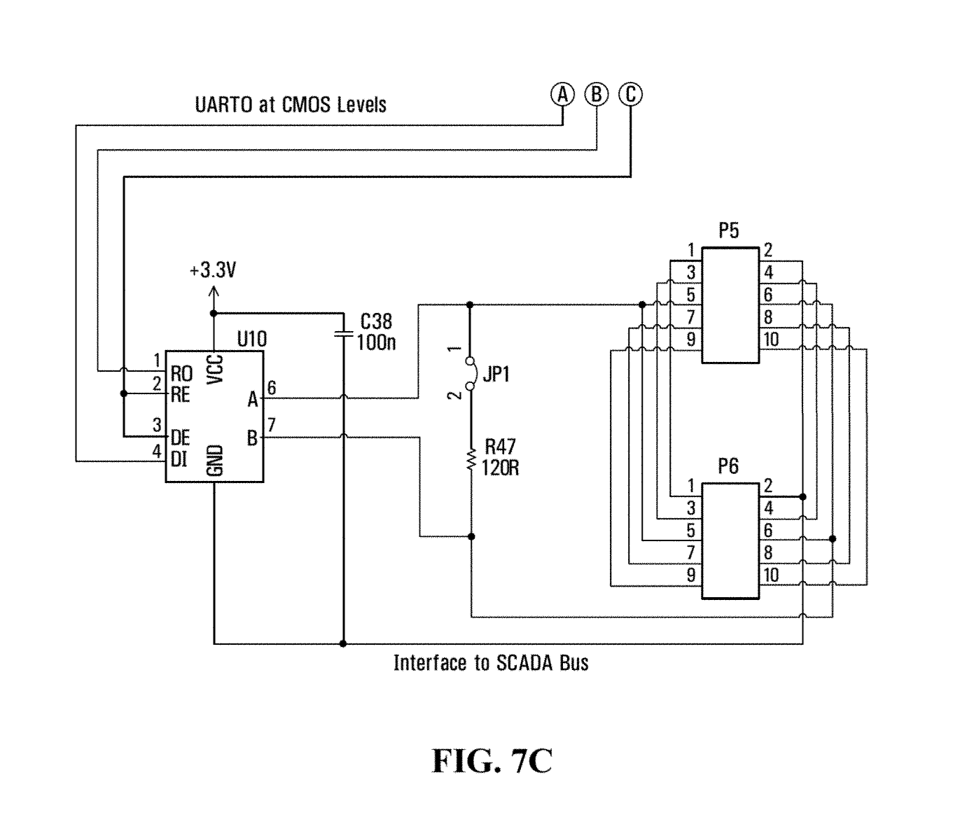

In one embodiment of the present disclosure the power converter 26 may comprise one or more input converters 26A and one or more output converters 26B, an example is shown in FIG. 3. FIG. 4 provides another schematic of an example of circuitry of one embodiment of the power conditioner 14 where the power converter 26 is comprised of an input converter and two output converters. The input converter 26A may comprise an input inverter 27 (shown in FIG. 5) that converts a DC electric-power input 22 into an AC output or an AC input into a DC output, which is also referred to herein as a DC link voltage. FIG. 5 shows one example schematic of the input inverter 27 that comprises an input-inverter controller 27B (FIG. 6) and an input inverter driver 27A (FIG. 7).

The input-inverter controller 27B may regulate the input converter 26A. The input-inverter controller 27B may be an analogue or digital microcontroller. The input-inverter controller 27B controls the power correction of the input converter 26A and a 3-phase rectifier. As discussed further below, the SCADA controller 28 controls the input-inverter controller 27B and the transfer of the conditioner output 24 to the primary load 16, which transfer may be referred to herein as the primary output 36, and the transfer of the conditioner output 24 to the secondary load 18, which transfer may be referred to herein as the secondary output 38.

In some embodiments of the present disclosure the requirements of the input converter 26A may be too complex and sophisticated to be implemented with an analog controller. For example in embodiments where the power-conditioning system 10 uses a turbine as the energy-capturing apparatus 20, this complexity may arise due to the input converter 26A regulating a DC link voltage and it must also sense the rotational speed of the energy-capturing assembly's 20 turbine. In other embodiments of the present disclosure that utilize, for example, a solar panel as the energy capturing apparatus 12 the input converter 26A may limit the power draw to remain within the power output capability of the energy-capturing assembly 12. Further, the input converter 26A may present a substantial capacitive load to the associated generator of the energy-capturing assembly 12 to compensate for the high inductance of the associated generator's windings, and the input converter 26A must react as the associated generator speed changes and as the power requirements of the primary and secondary loads 16, 18 change. Hence the input converter 26A requires independent control of three variables simultaneously: the DC link voltage, the real input-power, and the reactive input-power. To meet these requirements an all-digital input-inverter controller 27B may be useful.

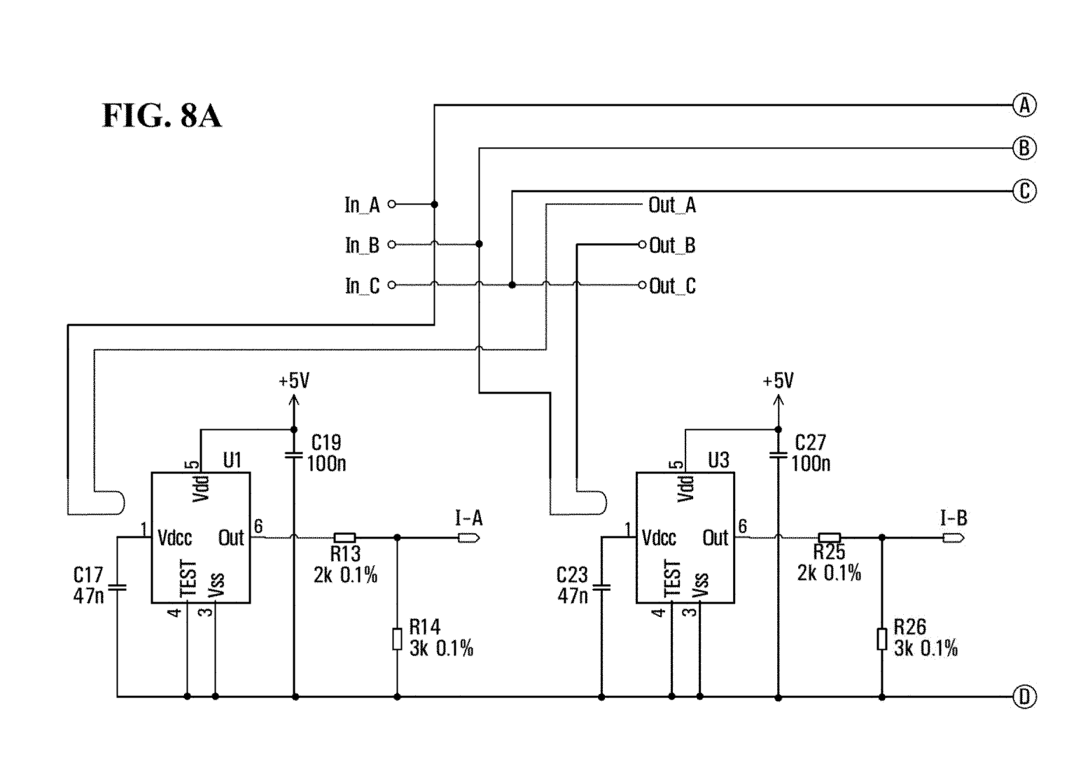

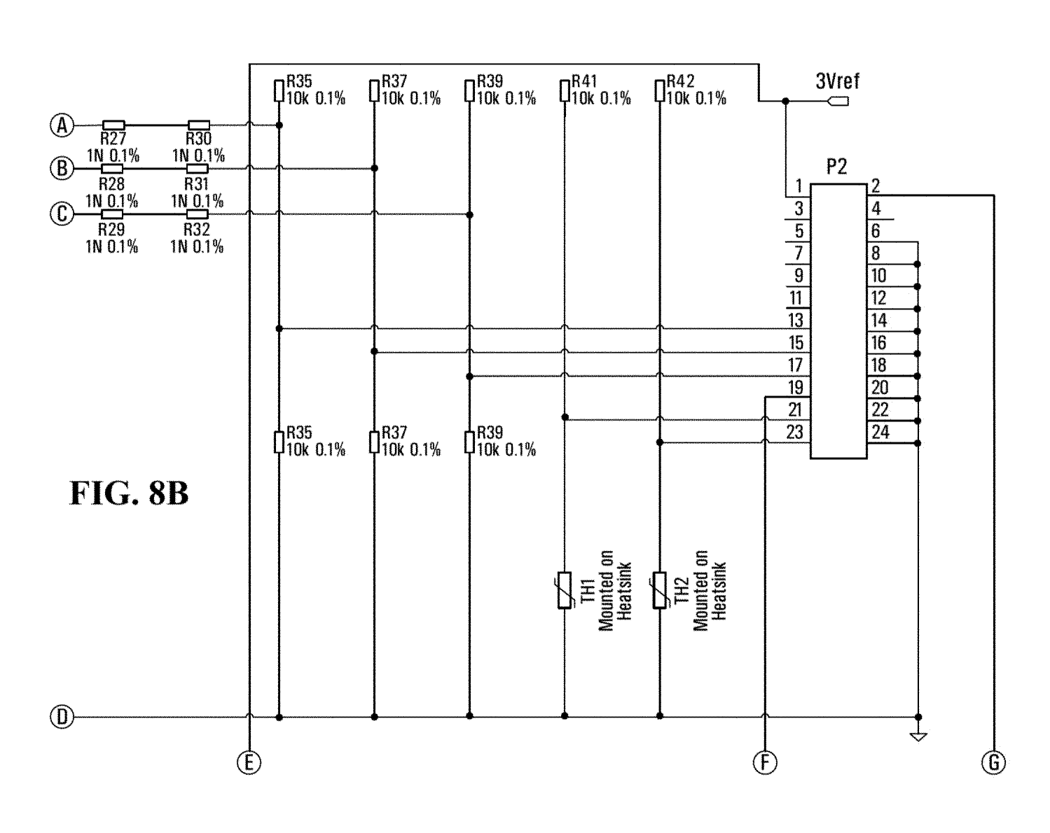

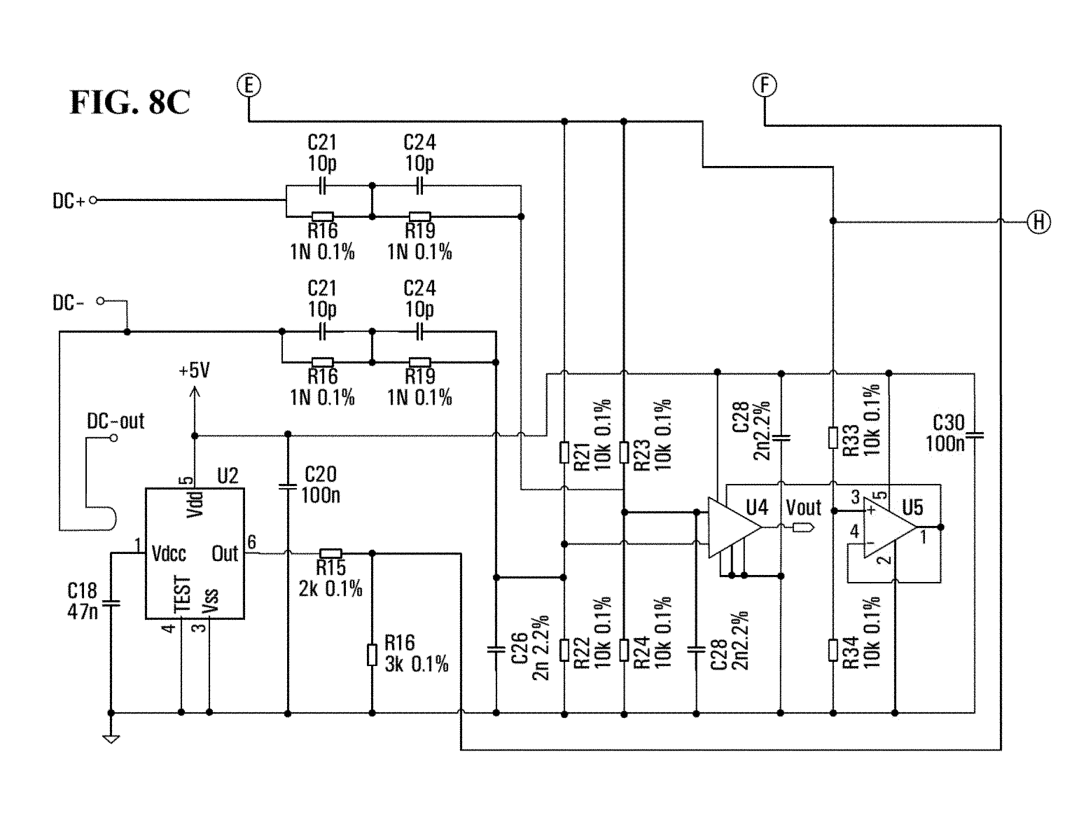

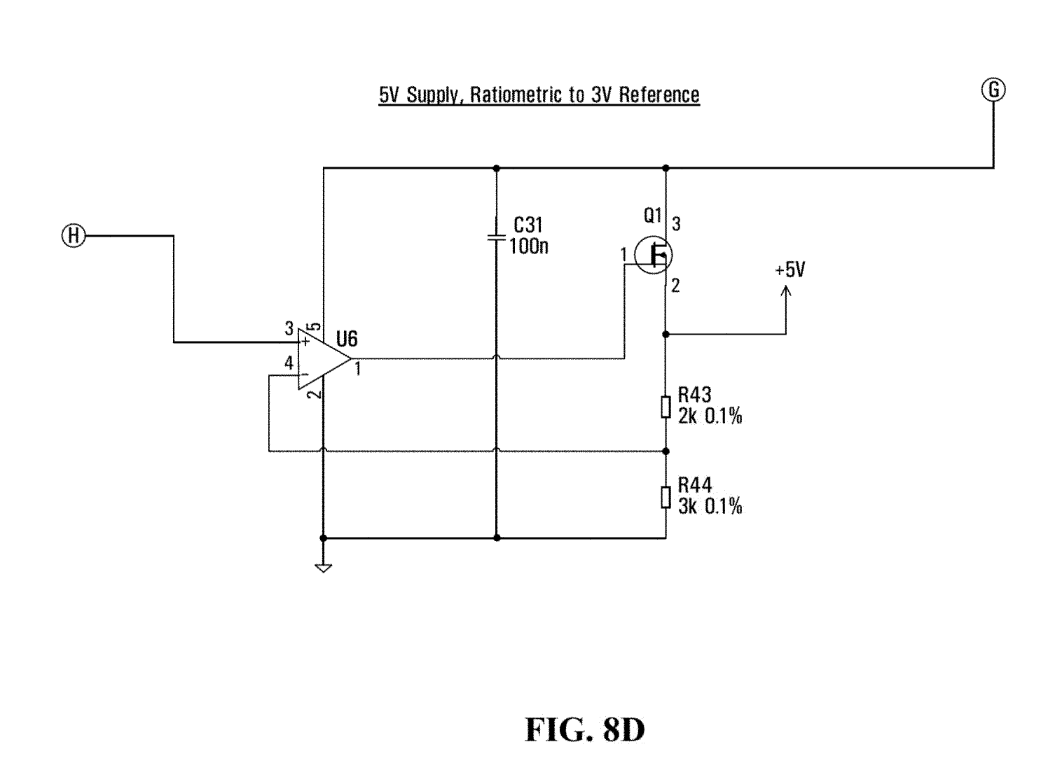

In one embodiment of the present disclosure the input converter 26A comprises sensors for detecting and measuring one or more of the following electric characteristics: input voltage, input current, input frequency from the associated generator, output voltage and output current. FIG. 8 shows an example of a schematic of the circuitry associated with these sensors in the form of an input converter instrumentation panel that gathers information from a 3-phase bus.

In order to reduce the overall weight of the power conditioner 14 the switching frequency of the input converter 26A may be as high as possible. To this end, the control algorithm of the input-inverter controller 27B may iterate at a minimum of 100,000 cycles per second. In one aspect, the input converter controller 27B may be a dual-core ARM® processor with a clock speed of 1 GHz, with a Gigabyte (GB) of fast DDR memory (ARM® is a registered trademark of ARM Holdings, Cambridge, UK) such as that used in an Olimex A20 processor board. This processor board has no peripherals connected, except for an analogue-to-digital converter used to sample the input currents and the DC link voltage at an iteration rate of the input-inverter controller 27B. An interface connects to the processor board via its GPIO2 connector. The interface may also connect the input-inverter controller 27B to the SCADA controller 28, which is discussed further below. The interface provides low-rate data from the SCADA controller 28 on the input voltages, and will set the targets for the input-inverter controller 27B to achieve.

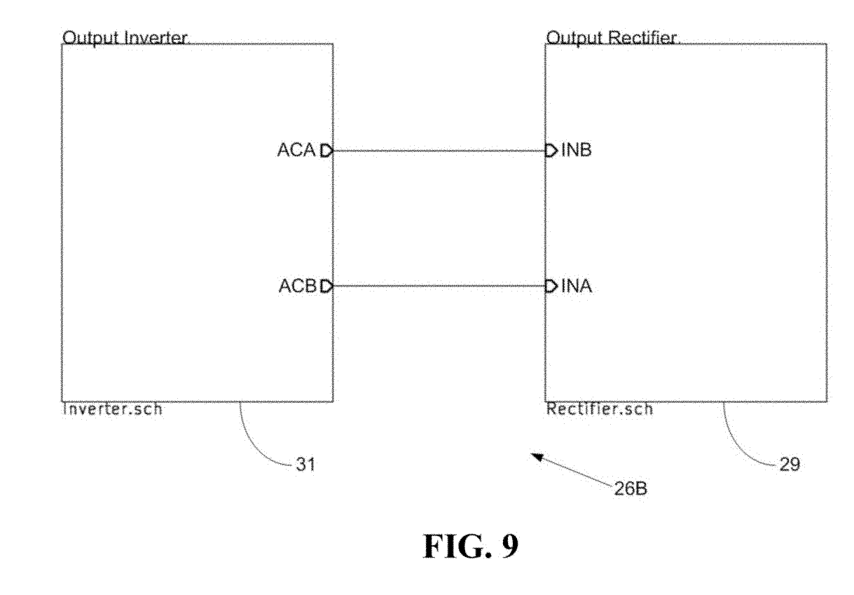

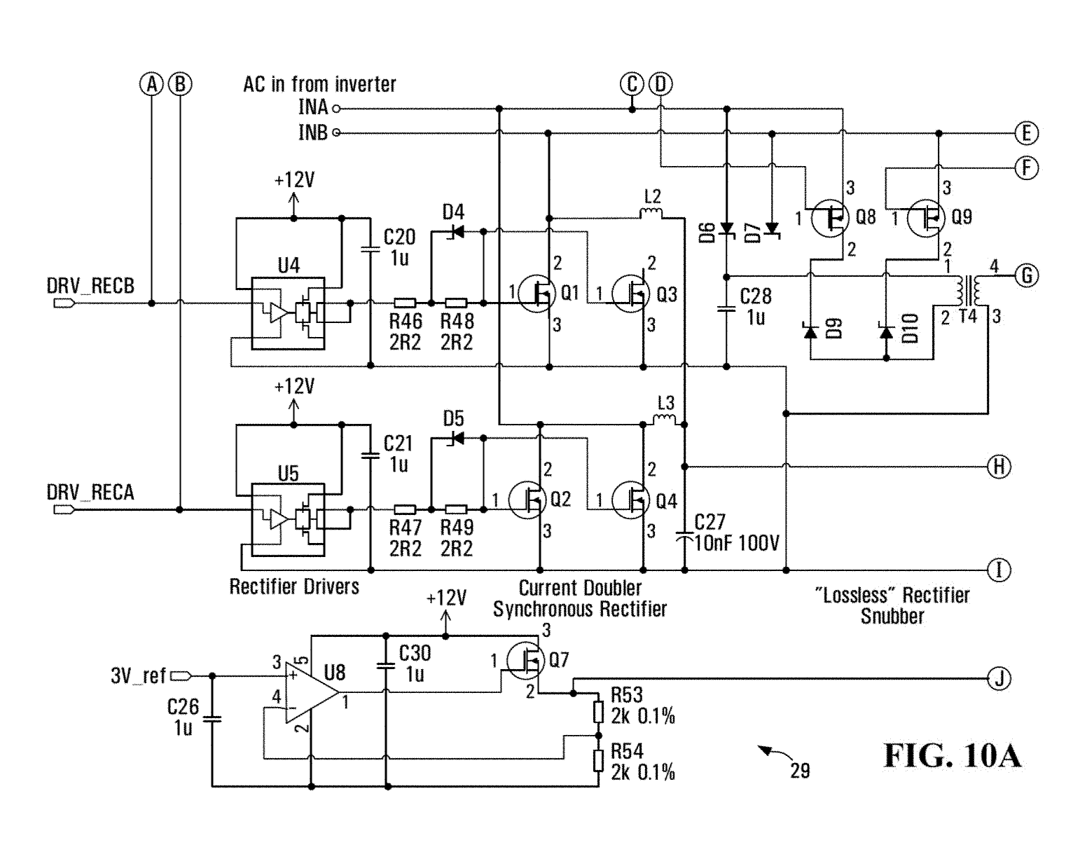

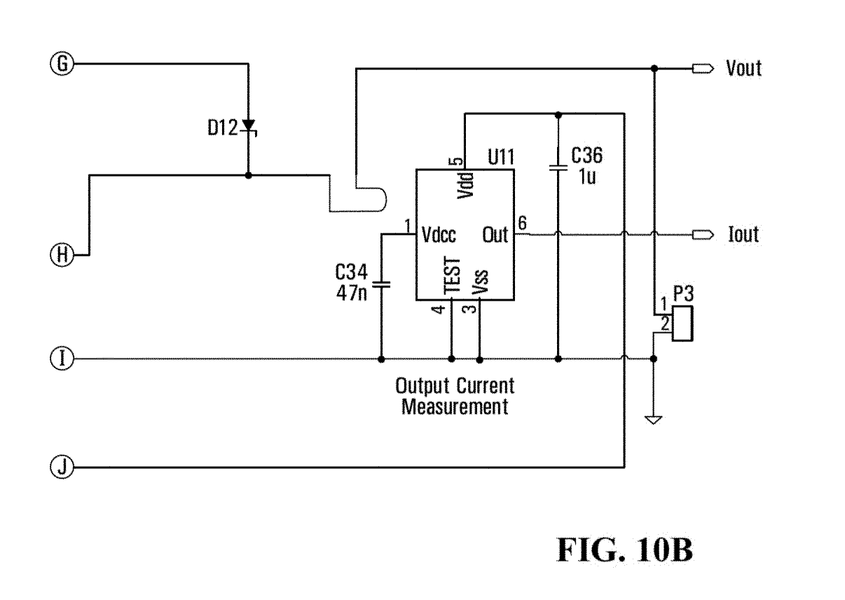

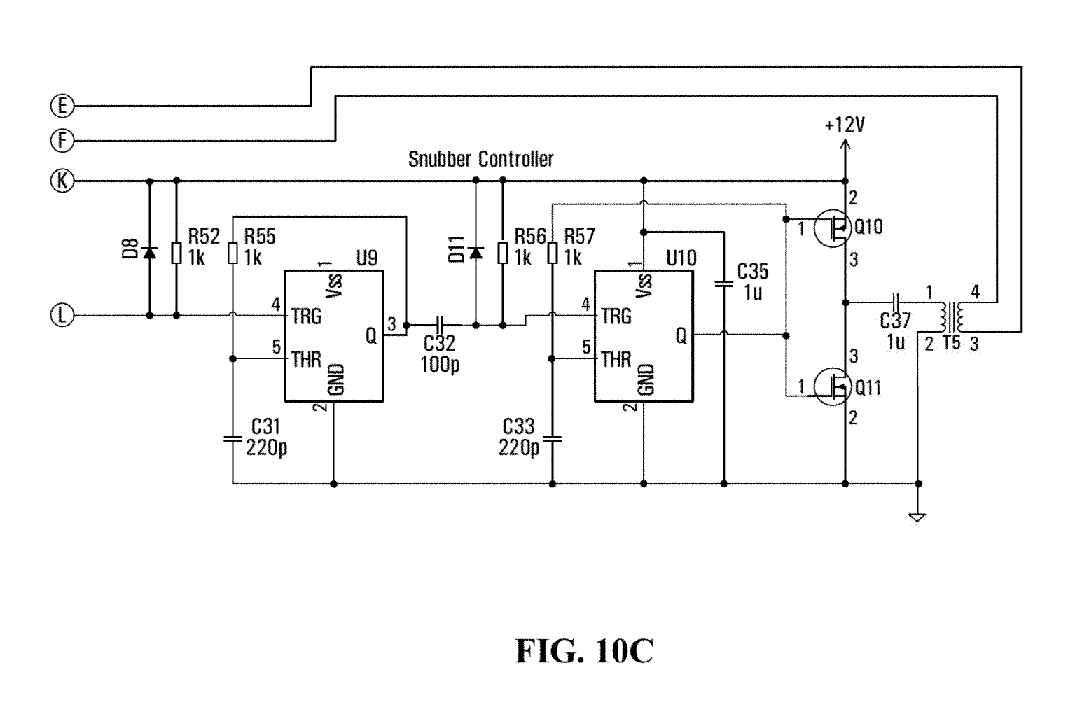

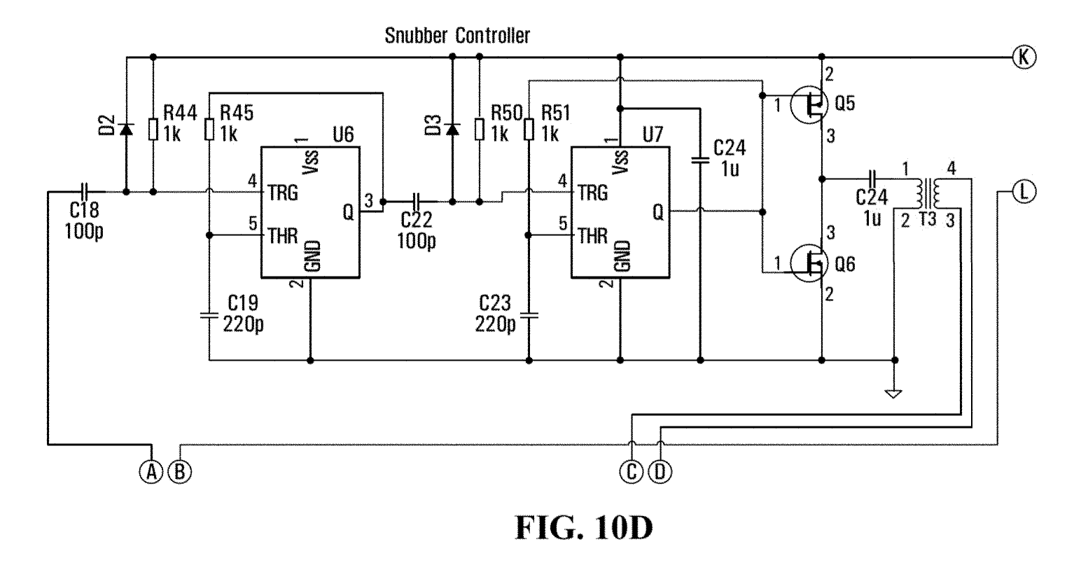

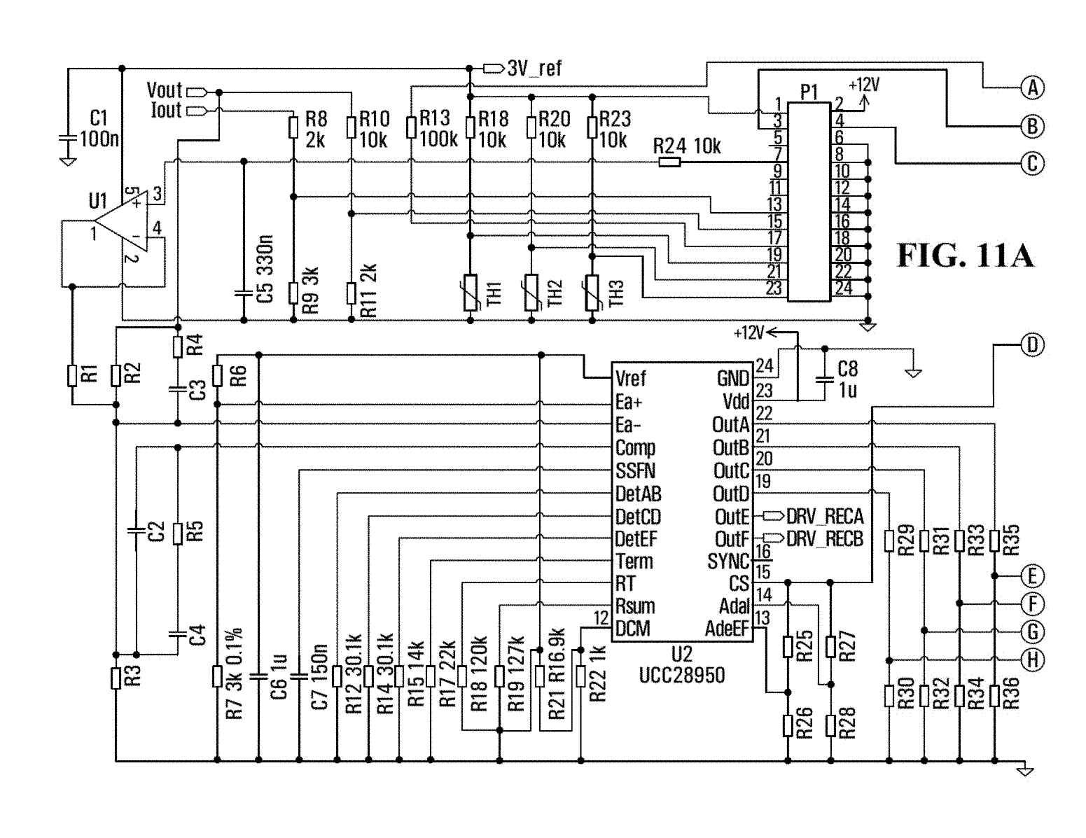

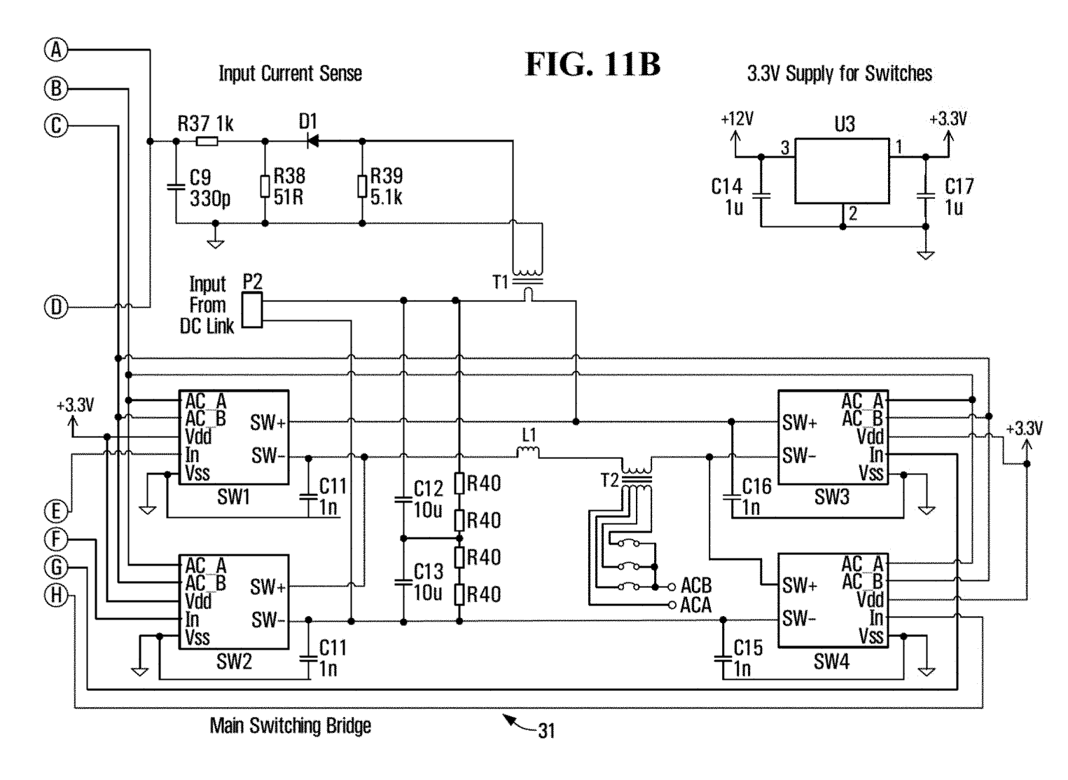

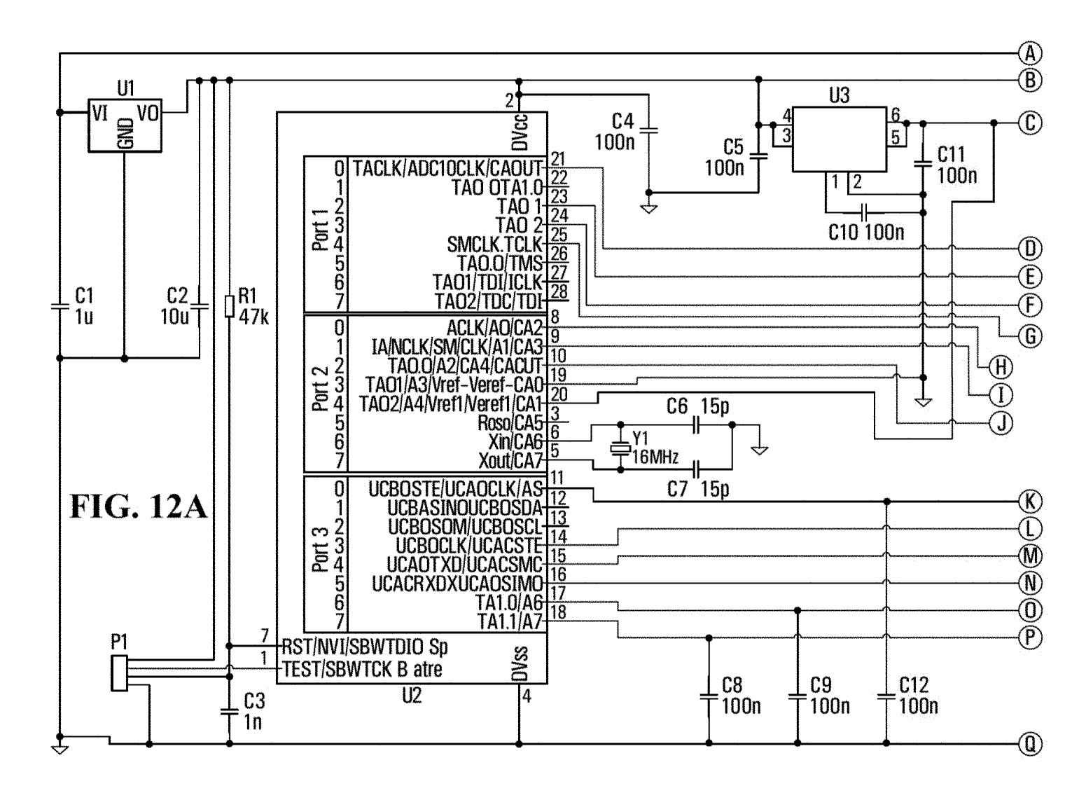

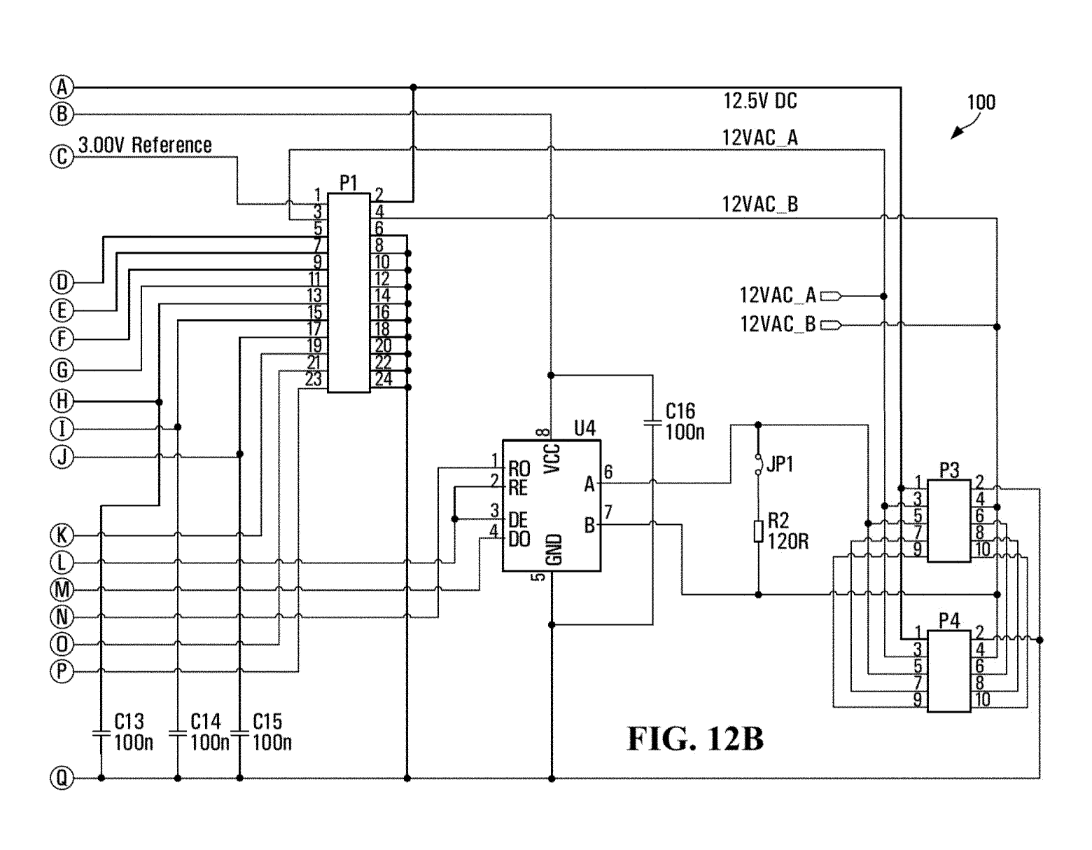

As shown in FIG. 9, the output converter 26B may comprise an output inverter 31 and an output rectifier 29. FIG. 10 shows one example of a schematic of the rectifier 29 and FIG. 11 shows one example schematic of the inverter 31 as well as an output inverter controller 52. In one embodiment of the output converter 26B the output converter 26B must provide a variable output voltage through pulse width modulation (PWM) in order to substantially infinitely or flexibly vary the output power. To meet these parameters an all-digital output inverter controller 52 is useful. For the sake of modularity, in one embodiment of the present disclosure, the output-inverter controller 52 may consist of the same processor as the input-inverter controller 27B. In one embodiment of the present disclosure the input converter 26A converts an AC power input 22 to a DC bus and an output converter 26B converters the DC bus to a DC power output 34. In order for both the input-inverter controller 27B and the output converter controller 52 to accurately convert their respective inputs to their respective outputs as well as maintaining safe operating temperatures, it is necessary to measure the voltage and current characteristics of their respective inputs and outputs and switching component temperatures. One example of an instrument board that can be used for measuring these required parameters is instrument board 100 (see FIG. 12). Additionally, this instrument board 100 is used to relay measured parameters to the SCADA controller 28 to enable informed power flow control for the overall power conditioner 14.

The primary-output terminal 30 drives the transfer of the primary output 36 to the primary load 16 based upon the power draw or power requirements of the primary load 16. In one embodiment of the present disclosure the controller 28 permits the primary-output terminal 30 to draw the total amount of electric energy within the conditioner output 34. In another embodiment, the primary-output terminal 30 has access to the total amount of electric energy within the conditioner output 34 without any control from the controller 28.

In one embodiment of the present disclosure the primary output 36 is substantially constant at about 50 V up to about 100 A. Alternatively, the primary output 36 may be selectable from about 12.5 V, about 25V or about 50 V with a maximum current of about 100 A for all voltage ranges.

In the event that the power draw of the primary load 16 is less than the amount of electric energy within the conditioner output 34, the SCADA controller 28 may transfer at least some of the conditioner output 34 to the secondary output terminal 32. The secondary output terminal 32 transfers that electric energy to the secondary load 16 in the form of the secondary output 38. The controller 28 may limit the total amount of electric energy that is transferred via the secondary output 38 to ensure that the sum of both the primary output 36 and the secondary output 38 is equal to or less than the total amount of power within the conditioner output 34. In other words, an aggregate amount of electric energy that is drawn by the first and second output terminals 30, 32 will not exceed the total amount of electric energy available from the conditioner output 34. This is achieved by the controller 28 limiting the amount of electric energy that is transferred to the secondary output terminal 32 while the amount of the conditioner output 34 that is transferred to the first output terminal 30 is based upon the power draw of the primary load 16.

The combination of the power converter 26, in particular a DC to DC converter or an AC to DC rectifier, and the ability of the SCADA controller 28 to direct excess electrical energy from the conditioner output 34 to the secondary output terminal 32 allows the power conditioner 14 to act as both a power source and a power sink. In this fashion, the power conditioner 14 may be said to mimic or emulate a battery or a bank of multiple batteries, which are collectively referred to herein as a battery.

In some embodiments of the present disclosure the aggregate power output from the first and second outputs 36, 38 may not exceed about 5 KW with an aggregate current output not exceeding 100 A.

In some embodiments of the present disclosure the primary output 36 may be selected to provide electric energy within a range that would typically be provided by a battery. Optionally, the second output 38 may also be selected to provide electric energy within a range that would typically be provided by a battery. The power conditioner 14 provides electric energy to any electrically connected load that could otherwise be provided by a battery. As described above, the power conditioner 14 can act as both an electric energy source and sink, which, in conjunction with the selected ranges of at least the primary output 36, alleviates the requirement of incorporating a battery within the power-conditioning system 10.

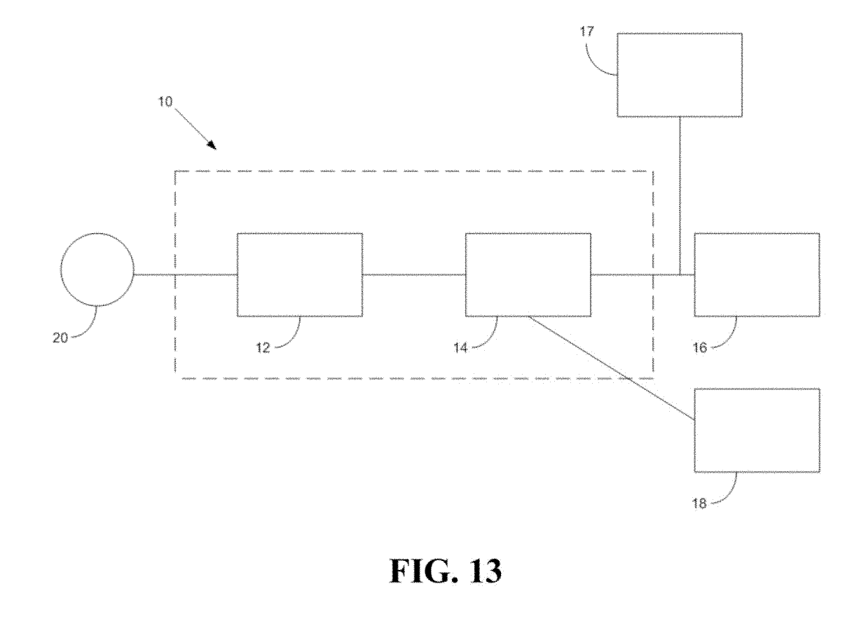

In one embodiment of the present disclosure the power-conditioning system 10 may comprise more than just the primary and secondary loads 16, 18 (see FIG. 13). For example, the power-conditioning system 10 may include a third load 17 that is electrically connected in parallel with the primary load 16 to receive a portion of the electric energy within the primary output 36. Optionally, the third load 17 may be an electric energy accumulator, such as a battery, that can store any excess amount of electric energy within the conditioner output 34 but that is not directed towards any other load that is actively using the electric energy. When the battery is being charged it may provide additional short-term power consumption in the event of an excess of electric energy is available from the conditioner output 34. If multiple batteries are connected in parallel with the primary load 16, the batteries will be similar in type and state of charge.

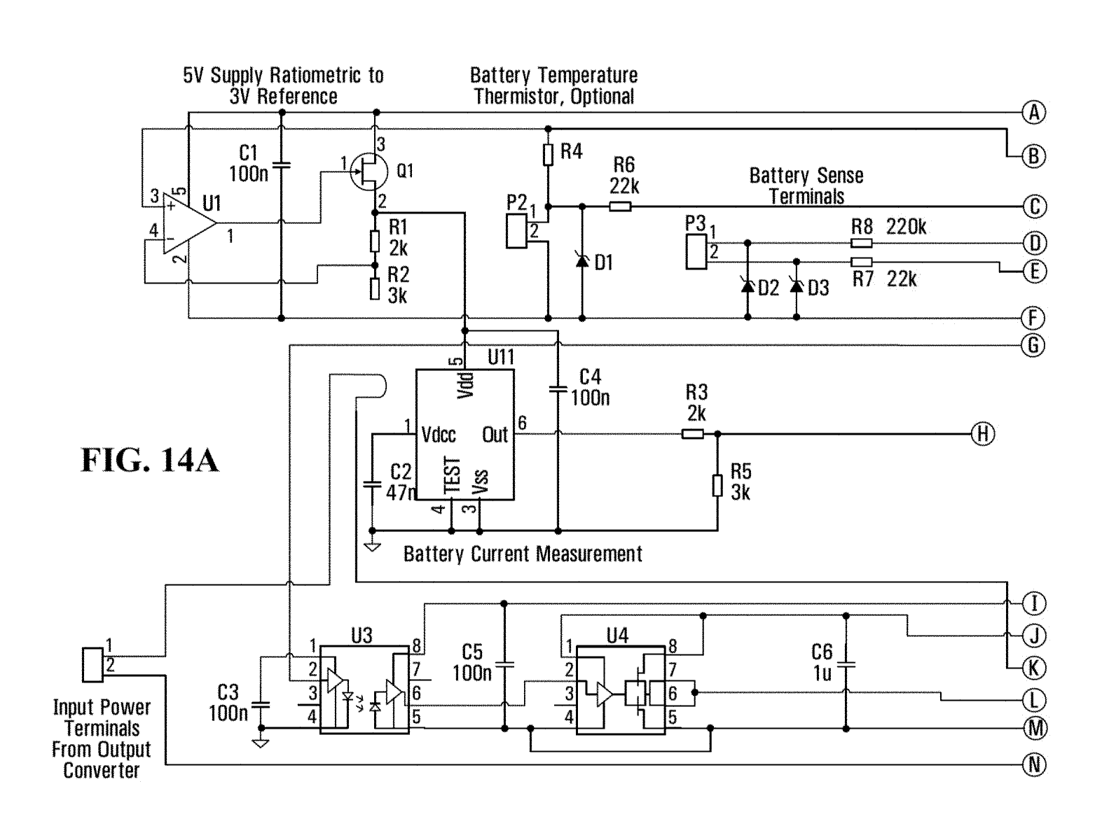

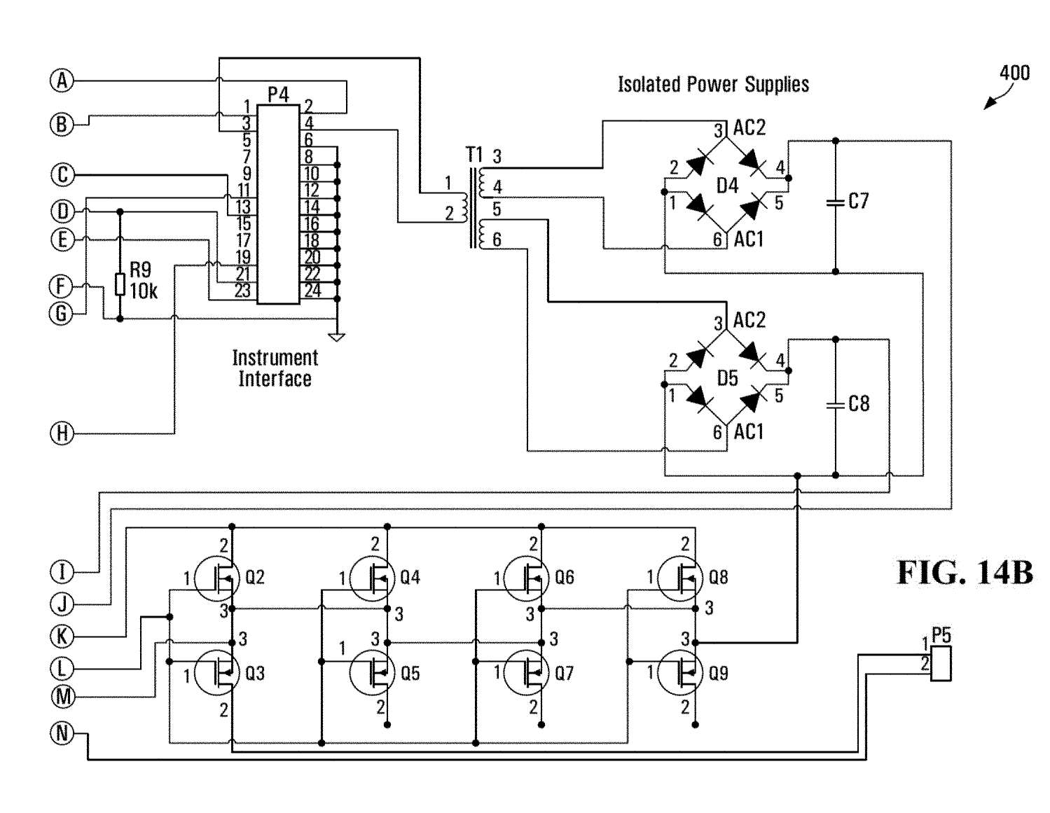

In one embodiment of the present disclosure the power conditioner 14 further comprises a battery management terminal 400 that has the capability to charge batteries with a nominal voltage, for example lead-acid batteries, nickel-based batteries or lithium-based batteries (see FIG. 14). For example these batteries may have a voltage of about 12 V, 24 V or 48 V. The power conditioner 14 may provide voltage to the battery management terminal 400 in the ranges of about 10.5 V to about 14.5 V, about 21 V to about 29 V and about 42 V to about 58 V, respectively. The battery management terminal 400 may comprise circuitry that prevents any battery that is electrically connected to the battery management terminal 400 from overcharging. The battery management terminal 400 will also prevent over discharge of an electrically connected battery. If a charged battery is electrically connected to the battery management terminal 400 and if the electric-power input 22 is insufficient to meet the demands of the primary load 16, the connected battery can provide power to the primary terminal 16. The battery management terminal 400 may or may not be electrically connected to the secondary output terminal 32 and, therefore, a connected and charged battery may or may not provide electric energy to the secondary load 18 through the battery management terminal 400. In one embodiment of the present disclosure the power-conditioning system 10 may include the SCADA system. The SCADA system may comprise the SCADA controller 28, processor board, a display and a keypad. The SCADA controller 28 may be used to provide supervisory control to the plurality of input inverter controllers 27B, the plurality of output inverter controllers 52, battery management terminal 400, and overvoltage protection switch. Furthermore the SCADA controller 28 may acquire data from the instrument circuits 100, 102, 104, and 400 and store measured parameters as time stamped log data. This data can be directed automatically to a USB flash drive. The log data may also be used by the processor of the SCADA controller 28 to calculate time-related measurements such as hourly means. The processor may store the log data within the memory portion for at least five years. Optionally, the newest log data may overwrite the oldest log data if the memory portion becomes full.

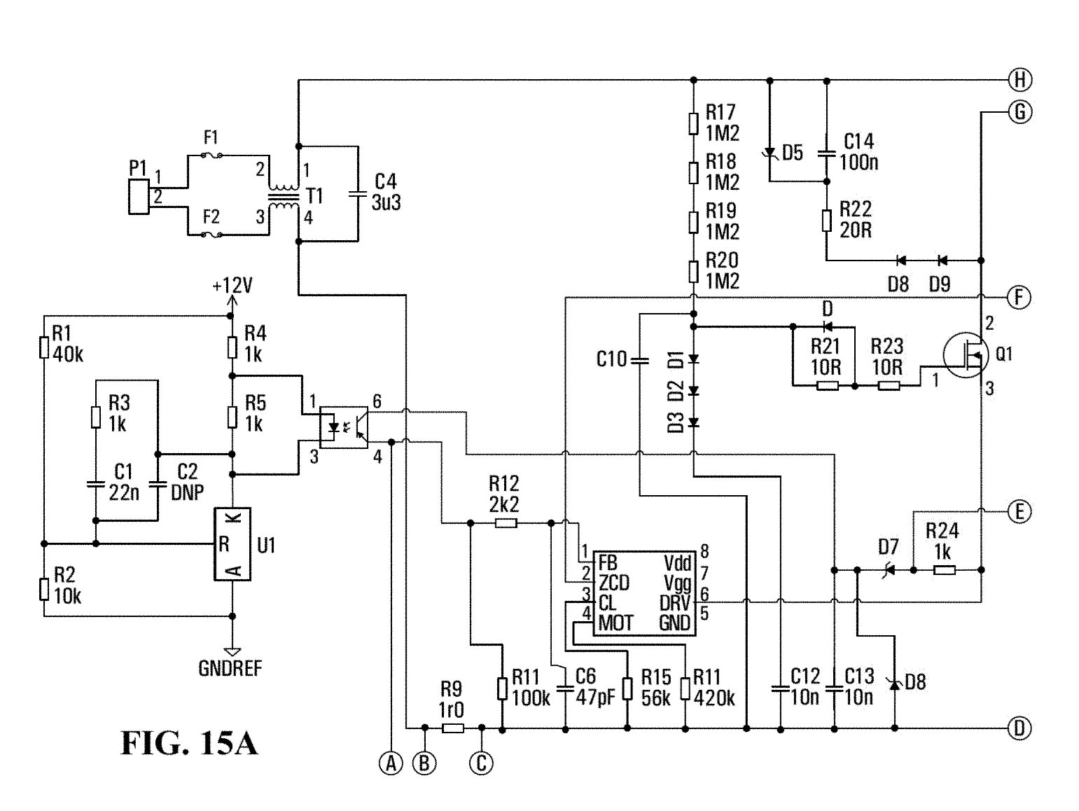

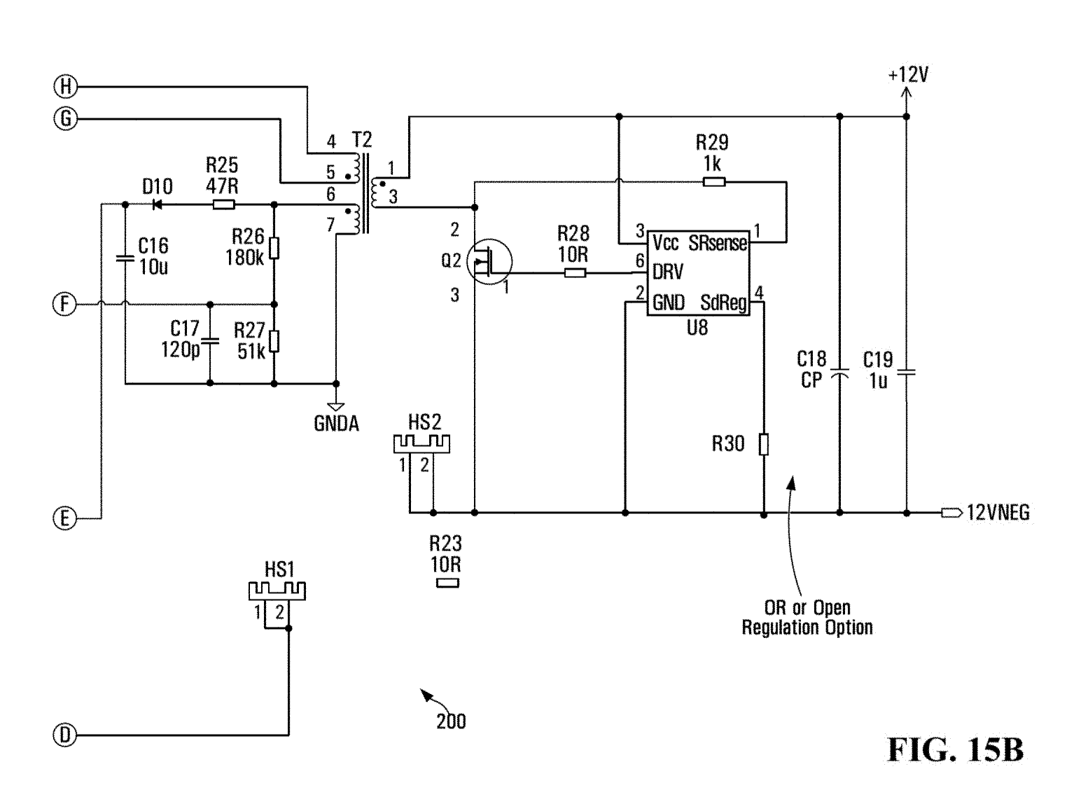

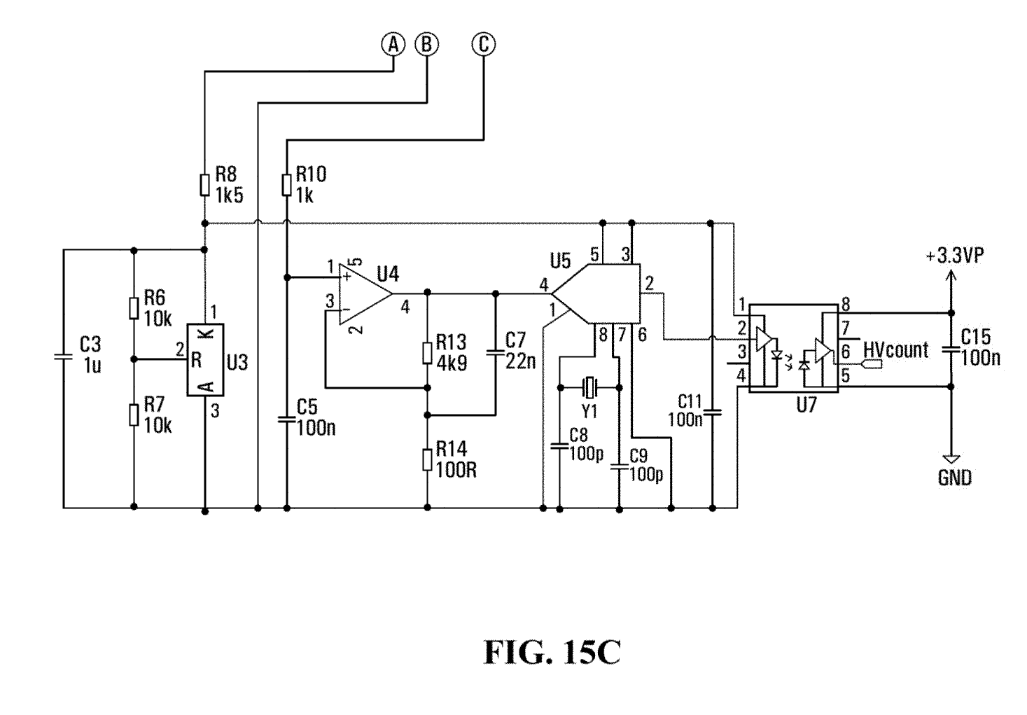

In one example, the SCADA system may use an Olimex A20 processor board that drives a 4.3″ monochrome TFT display and a keypad. The processor board has a Real-Time Clock module that may be battery backed to preserve time and date information if the power-conditioning system 10 is powered down. The dual-processor 1 GHz ARM processor, described above provides the processing power and it stores all of its program and log data in an onboard 4 GB flash memory. Electrical power for the processor board may be provided by the auxiliary power supply 200 (as shown in FIG. 15). The processor board may interface with a SCADA bus by means of an RS485 module. A packet protocol on the bus allows the SCADA system to interrogate each of the instrumentation boards 100, 102, 104 and 400 of the power-conditioning system, and to control the operation of the power-conditioning system 10.

In one embodiment of the power-conditioning system 10, a winch may optionally be physically coupled to a water turbine energy-capturing assembly 12 for inserting and withdrawing the water turbine from the flowing-water energy source 20. The winch may be electronically connected, which is also referred to as electronically connectible, to the power conditioner 14 by an isolated relay so that the winch may receive an overvoltage signal which indicates an overvoltage state was detected at the input electric-power input 22. Upon receiving the overvoltage signal, the winch can activate and withdraw the water turbine from the flowing water. Sustained excessive voltage within the electric-power input 22 may be caused by a turbine over-speed condition which requires removal of the turbine from the flowing-water energy source 20.

In another embodiment, the power conditioner output relay may be used to actuate the brake on the energy-capturing assembly 12 when it is a turbine in the event an over speed situation occurs.

Optionally, the power-conditioning system 10 is capable of black starts, which are also referred to as cold starts. One embodiment of the present disclosure further comprises an auxiliary power supply to facilitate a black start by providing power to the power-conditioning system 10. During a black start the SCADA controller 28 and the input-inverter controller are not operating so when the associated generator of the energy-capturing assembly 12 is a permanent magnet generator that starts running, freewheel diodes that bridge across the switching components in the input converter 26A are used to perform diode-based rectification. This results in an energized DC link. The auxiliary power supply uses that DC link voltage to energize the SCADA controller 28, input-inverter controller 27B, output inverter controller 52, and all the sensor instrument circuits required for the operation of these systems. Then the SCADA controller 28 commands the input-inverter controller 27A to start performing active or transistor-based rectification, at which point the power factor coming from the associated generator is corrected—it is possible to emulate a capacitive load—and the output converter controller 52 is initiated.

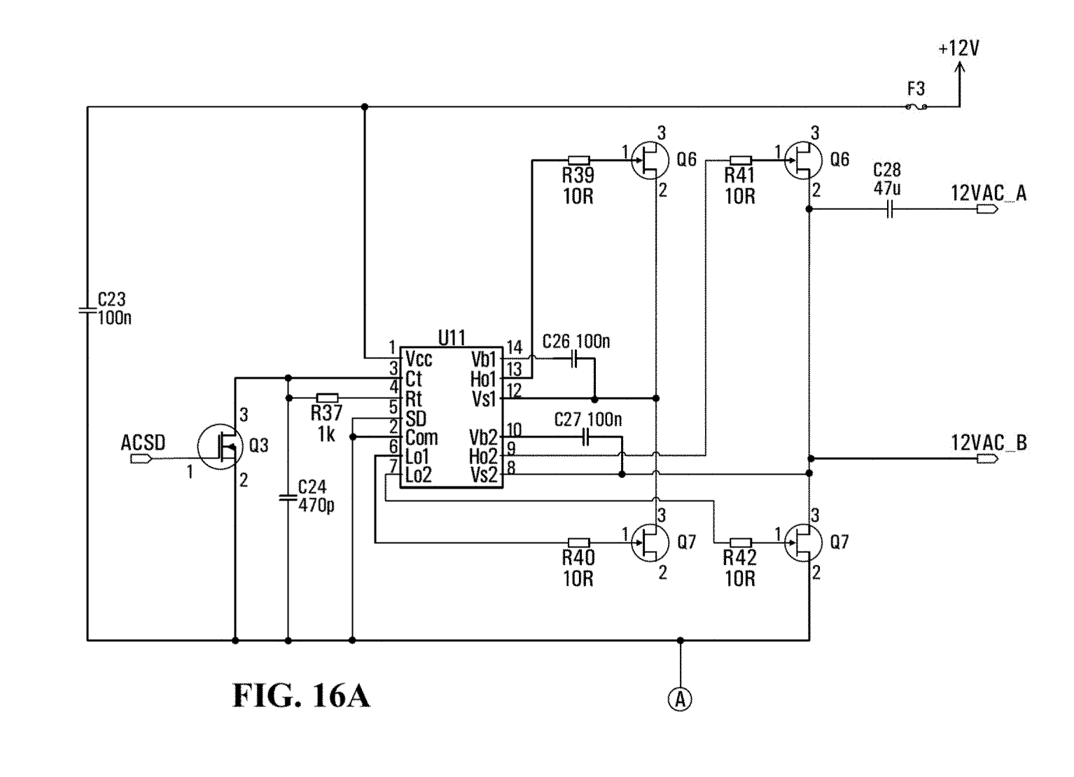

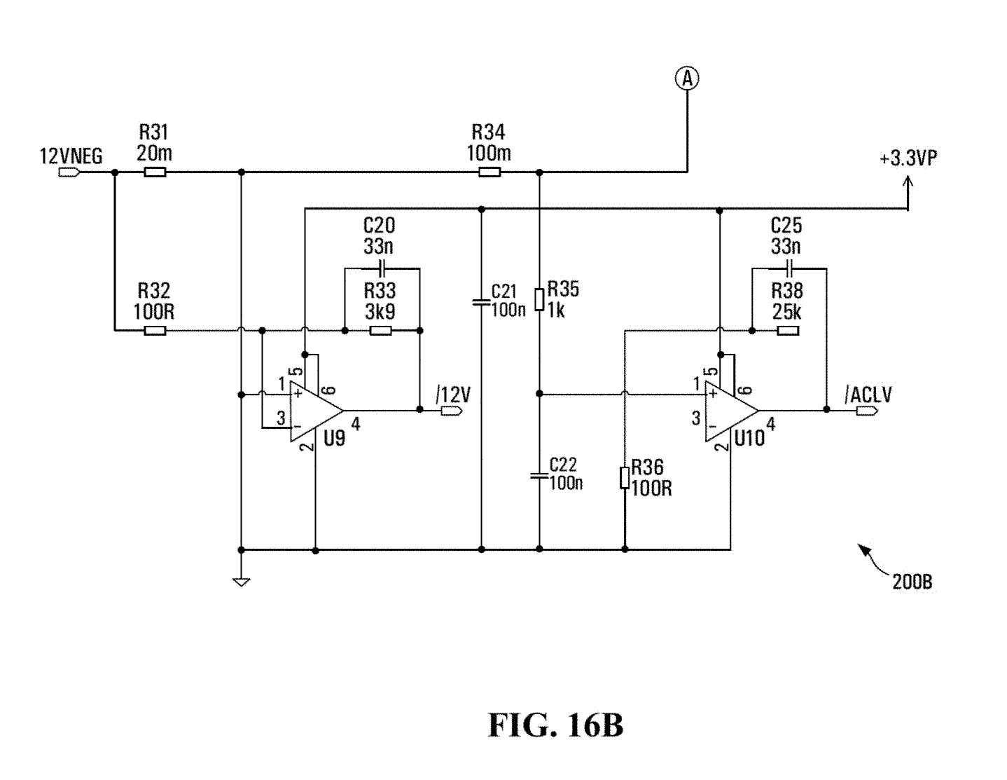

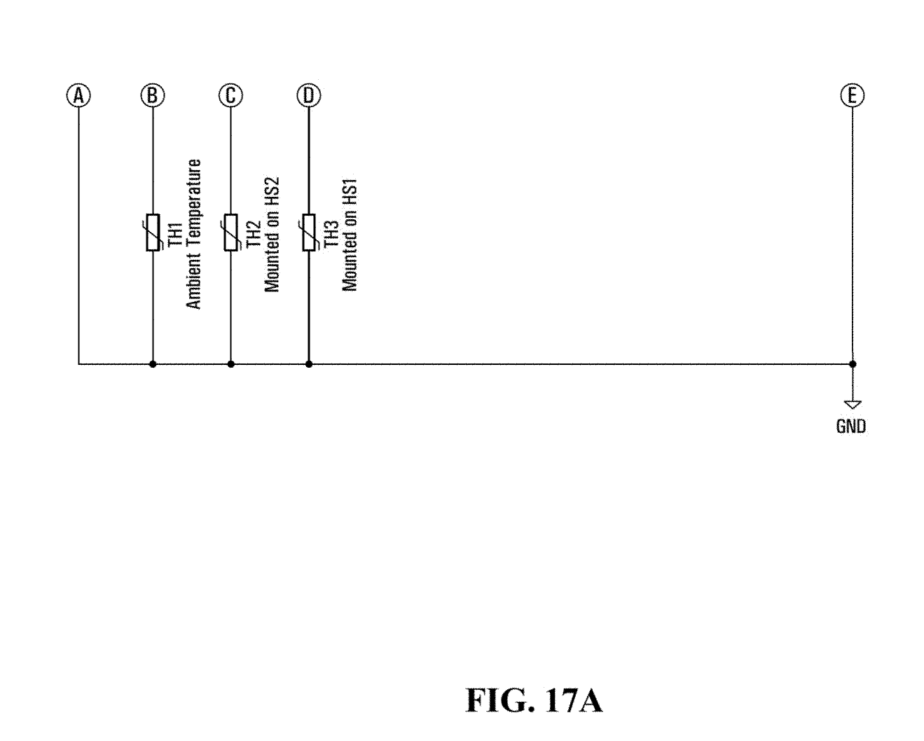

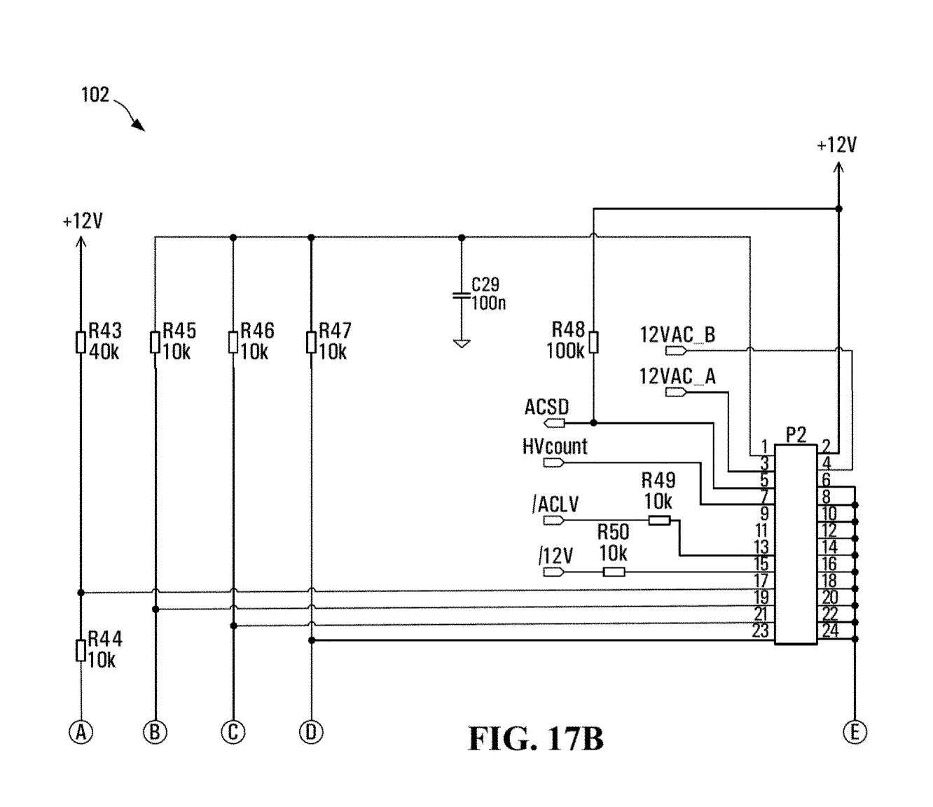

In one embodiment of the present disclosure, the auxiliary power supply 200 comprises three components: (I) a DC to DC converter 200A (see FIG. 15) which regulates the variable DC link voltage down to 12 Volts DC; (II) an DC to AC inverter 200B (see FIG. 16) which creates 12 VAC from 12 VDC, because 12 VAC is required for the operation of the switches within the power conditioner 14; and (III) an auxiliary supply instrumentation board 102 (see FIG. 17) which provides operational feedback from the auxiliary power supply 200 to the SCADA controller 28.

The terminals 24, 30, 32, 400 of the power-conditioning system 10 can tolerate fault conditions that may arise from open or short circuits. When the fault condition is corrected, the power-conditioning system 10 may re-start, optionally, following a cool down period.

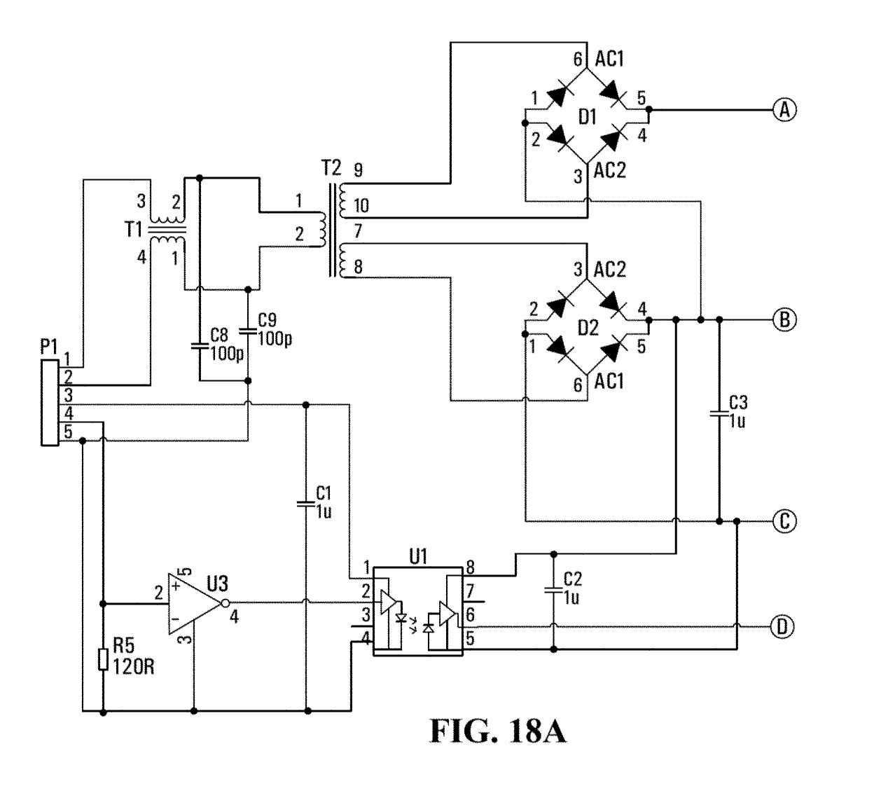

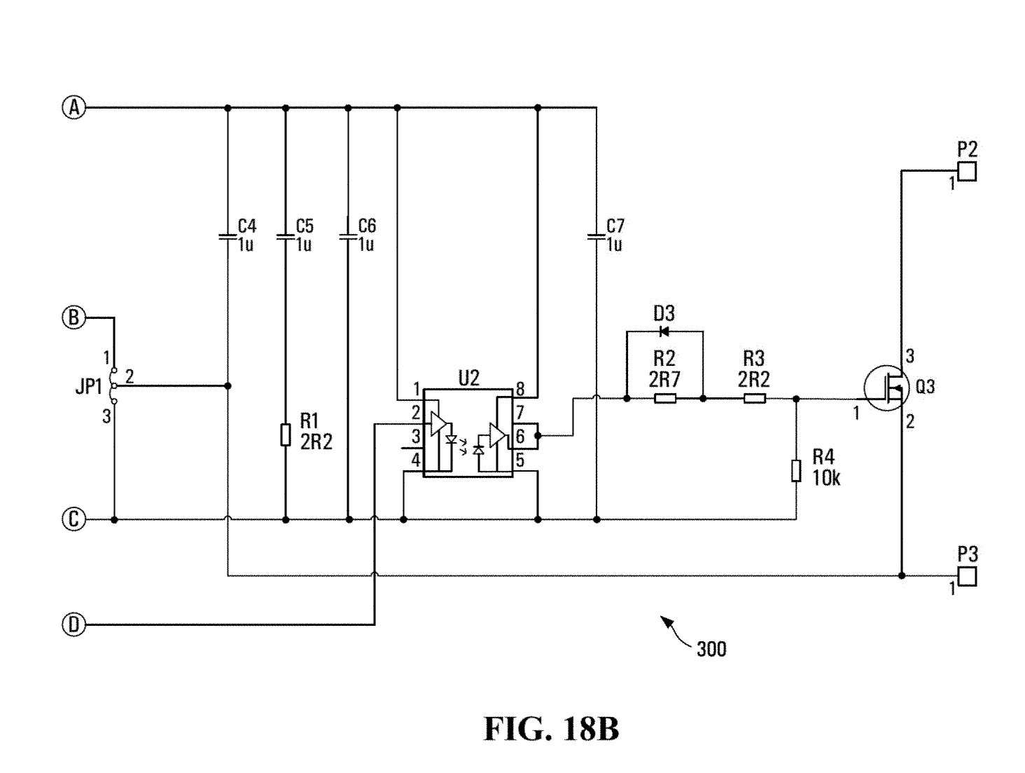

In one embodiment of the present disclosure the power conditioner 14 further comprises one or more switch components 300 that may be used throughout the power conditioner 14 (see FIG. 18). For example, there may be between about 5 and about 10 switch components 300 in the input converter 26A. One or more switch components 300 may be used in the output converter 26B. One or more switch components 300 may be used as an over-voltage switch that can actuate to direct the electric-power input 22 to an external resistor (not shown) if the electric-power input 22 is about 400 VAC or higher. The overvoltage switch 300 may also be referred to as an isolation switch. When the switch 300 is actuated, the power conditioner 14 can still monitor the voltage and frequency of the electric-power input 22 to determine when the overvoltage state has passed. When the overvoltage state has passed, the overvoltage switch 300 can be actuated again to direct the electric-power input 22 back to the power converter 26. The switch component 300 is but one example of how the power-conditioning system 10 may use many modular components that can be easily repaired or replaced on site rather than having to move the power-conditioning system 10, from a remote location where the power-conditioning system 10 is installed, to a repair facility.

In one embodiment of the present disclosure the power-conditioning system 10 is modular and scalable. In this embodiment, at least two energy-capturing assemblies 12 may be used. For example, two or more water turbines, two or more solar panels, two or more wind turbines, or combinations thereof may be used. Each turbine may be used to drive a respective associated-generator, or not in the case of solar panels or other chemical-based energy-capturing assemblies 12. Each of the at least two energy-capturing assemblies 12 may produce an electric-power input 22 that is transferred to a respective input terminal 24, a common input terminal 24 of the power conditioner 14 or more than one power conditioner 14 may be provided. In some embodiments of the present disclosure, the power-conditioning system 10 may comprise a second-energy-capturing assembly 12A that produces a second electric-power input 22A and a second power conditioner 14A that receives the second electric-power input 22A (see FIG. 19). The outputs from the power conditioners 14, 14A may be parallelized to provide a scalable primary output 36′ and, optionally, a scalable secondary output 38′.

In other embodiments of the present disclosure, there may be a one-to-one ratio of two or more energy-capturing assemblies 12 to two or more power conditioners 14. The primary output 36 and, optionally, the secondary output 38 from the two or more power conditioners 14 may be parallelized.

In some embodiments of the present disclosure the power-conditioning system 10 is mobile. Both of the energy-capturing assembly 12 and the power conditioner 14 are of a size, shape and weight that permit each to be physically carried by an able bodied person or carried by an animal. For example, the energy-capturing assembly 12 is modular and capable of being assembled from many smaller components into a water turbine that measures about 5 feet by 5 feet by 8 feet (5′×5′×8′) and weights between about 500 pounds and 700 pounds. The power conditioner 14 may be about 20 inches by about 20 inches by about 6 inches (20″×20″×6″) and weighs between about 20 pounds and about 50 pounds. When the power-conditioning system 10 is mobile it can be transported to and set up within remote locations that have no access to a power transmission or distribution grid. Furthermore, with the example dimensions and weights provided above, the power-conditioning system 10 may be transported to and set up in very remote areas that also do not have road access. Transporting and setting up a typical power generating or conditioning system in such remote areas may be limited by the weight of any batteries.

Because the power-conditioning system 10 is intended to be transported into and used in remote and very remote locations, the various components may be designed and built with both overall weight and durability as important considerations. The power-conditioning system 10 may operate in a range of ambient temperatures of between about −20° Celsius (C) to about 70° C. The power-conditioning system 10 may operate at various altitudes, for example between sea level and about 4 kilometers above sea-level. The power-conditioning system 10 may also operate at humidity levels that range between 0 and 100% humidity, which can include condensing conditions. Optionally, the power-conditioning system 10 is not susceptible to dripping water or salt water. The electromagnetic compatibility (EMC) susceptibility may also be low because the primary load 16 may be a portable cellular network tower.

1. A mobile power-conditioning system comprising:
a. an energy-capturing assembly for capturing energy from an energy source and converting the captured energy into an electric-power input;
b. a power conditioner that is electrically connectible to the energy capturing assembly for receiving the electrical power input and delivering a conditioned electrical power output of a substantially constant voltage, the power conditioner comprising:
i. an input terminal for receiving the electric-power input from the energy capturing assembly;
ii. a primary output terminal that is configured to receive and transfer at least a portion of the conditioned electrical power output to a primary load;
iii. a secondary output terminal that is configured to receive an un-transferred portion of the conditioned electrical power output and for transferring the untransferred portion to a secondary load; and
iv. a controller that is configured to regulate a transfer of the un-transferred portion of the conditioned electrical power output to the secondary output terminal so that an aggregated draw from both the primary output terminal and the second output terminal is less than or equal to the conditioned electrical power output.

2. The mobile power-conditioning system of claim 1, wherein the energy-capturing assembly comprises:
a. a turbine for converting potential and kinetic energy of a flowing fluid into physical work; and
b. an associated generator for converting the physical work into the electric-power input.

3. The mobile power-conditioning system of claim 2, wherein the turbine is a water turbine.

4. The mobile power-conditioning system of claim 1, wherein the energy-capturing assembly comprises one or more solar panels.

5. The mobile power-conditioning system of claim 1, wherein the electric-power input is an alternating current (AC) or a direct current (DC) with a substantially constant voltage or a variable voltage.

6. The mobile power-conditioning system of claim 5, wherein the electric-power input is a substantially constant current or a variable current.

7. The mobile power-conditioning system of claim 1, wherein the electric-power input is within a power range of about 10 watts (W) to about one megawatt.

8. The mobile power-conditioning system of claim 1, wherein the controller is a supervisory control and acquisition system (SCADA) controller.

9. The mobile power-conditioning system of claim 1, wherein the power conditioner further comprises a power converter for conditioning the electric-power input into the conditioner electric power output with a substantially constant current or a substantially variable current.

10. The mobile power-conditioning system of claim 1, wherein the conditioner electric power output meets operational requirements or preferences of the first load and the second load.

11. The mobile power-conditioning system of claim 1, further comprising a third load that is electrically connectible in parallel with the first load for receiving at least a portion of the transferred portion of the conditioned electrical power output.

12. The mobile power-conditioning system of claim 1, wherein the power conditioner further comprises a battery management terminal for charging batteries.

13. The mobile power-conditioning system of claim 3, further comprising a winch that is coupled to the water turbine, wherein the winch is electronically connectible to the power conditioner for receiving an overvoltage signal therefrom, wherein the overvoltage signal indicates an excessive voltage state at the input terminal and upon receiving the overvoltage signal the winch is configured to withdraw the water turbine from the flowing fluid.

14. The mobile power-conditioning system of claim 1 further comprising an auxiliary power supply for powering the mobile power-conditioning system during a black start.

15. The mobile power-conditioning system of claim 1 wherein the energy-capturing assembly weighs between about 500 pounds and about 700 pounds.

16. The mobile power-conditioning system of claim 1 wherein the and wherein the power conditioner weighs between about 20 pounds and about 50 pounds.

17. A method for providing electrical power, the method comprising steps of:
a. capturing chemical energy or potential energy and kinetic energy from an energy source;
b. converting the captured energy into an electric-power input;
c. transferring the electric-power input to a power conditioner;
d. conditioning the electric-power input for making a conditioned electrical power output;
e. transferring a first portion of the conditioned electrical power output to a primary load; and
f. transferring a second portion of the conditioned electrical power output to a secondary load;
wherein together an aggregated power of the first portion and the second portion are equal to or less than the conditioned electrical power output.
